(19) United States
(12) Patent Application Publication
(10) Pub. No.: US 2006/0050786 A1
(43) Pub. Date: Mar. 9, 2006

(54) Moving picture coding apparatus and computer program product

(75) Inventors: Akiyuki Tanizawa, Kanagawa (JP); Wataru Asano, Kanagawa (JP); Shinichiro Koto, Tokyo (JP); Takeshi Chujoh, Kanagawa (JP); Naomi Takeda, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/176,755

(22) Filed: Jul. 8, 2005

(30) Foreign Application Priority Data
Sep. 9, 2004 (JP) 2004-263085

(51) Int. Cl. H04N 11/04; H04B 1/66; H04N 7/12; H04N 11/02

(52) U.S. Cl. 375/240.03; 375/240.12; 375/240.18; 375/240.24

(57) ABSTRACT

A moving picture coding apparatus includes a prediction signal generating unit that generates a prediction signal for each coding mode from an input image of an interlaced moving picture and a reference image to generate a prediction error signal; a candidate mode selecting unit that selects a candidate coding mode based on a first coding cost calculated from the prediction error signal; a tentative coding unit that calculates a bitrate for each coding mode; a coding mode control unit that determines a coding mode among candidate coding modes based on a second coding cost calculated from the bitrate; and a coding unit that performs coding according to the determined coding mode on the prediction error signal with a coding structure decided based on the second coding cost.

### CROSS-REFERENCE TO RELATED APPLICATIONS

This application is based upon and claims the benefit of priority from the priority Japanese Patent Application No. 2004-263085, filed on Sep. 9, 2004; the entire contents of which are incorporated herein by reference.

### BACKGROUND OF THE INVENTION

1. Field of the Invention

The present invention relates to a moving picture coding apparatus and a computer program product which selects any one of coding mode from a plurality of coding modes representing different coding process methods for an interlace-type moving picture to be input to perform a coding process.

2. Description of the Related Art

As a technique of a moving picture coding process, international standards called ITU-T Rec. H. 264 and ISO/IEC 14496-10 (hereinafter referred to as “H.264”) using prediction coding having a plurality of prediction modes or a plurality of block sizes.

In the moving picture coding technique defined by H. 264, coding structures such as a frame structure, a field structure, an MBAFF structure, a PICAFF structure, and a PIC/MBAFF structure are regulated in accordance with characteristics of input images such as a progressive image and an interlace image to improve coding efficiency.

The MBAFF structure is a coding structure, which can adaptively select a frame macroblock pair and a field macroblock pair for a pair of macroblocks. The PICAFF structure is a coding structure, which can adaptively switch a frame picture and a field picture for respective pictures. The PIC/MBAFF structure is a coding structure, which can adaptively switch the MBAFF structure and the PICAFF structure. These coding structures are used for an interlace-type moving picture to make it possible to improve coding efficiency.

In H. 264, a plurality of block sizes and a plurality of prediction signal generating methods are prepared, a single coding mode is selected for each pixel block from coding modes defined by combinations of the block sizes and the prediction signal generating methods, a coding method using the block size and the prediction signal generating method defined by the selected coding mode is employed.

In the moving picture coding method, in coding, a coding mode having the highest coding efficiency is preferably selected, and the quality of an image to be reproduced is dependent on the selection. More specifically, when the coding mode is not optimally selected, in comparison with when the optimum selection is made, image quality obtained when a moving picture is coded at a constant bit rate becomes deteriorated, and a bitrate required to reproduce the moving picture with constant image quality increases. Therefore, it is important problem to appropriately select a coding mode for each pixel block. As a conventional technique, a technique related to selection of coding modes is disclosed.

More specifically., in Japanese Patent Application Laid-Open (JP-A) No. 2003-153280, a first conventional technique in which a coding mode having the minimum prediction error is selected is disclosed. In JP-A No. 10-290464, a second conventional technique in which a bitrate is estimated based on prediction error signal or the like to select a coding mode the estimated bitrate of which is minimum is disclosed. In JP-A Nos. 2003-153280 and 9-322176, a third conventional technique in which a coding process is actually executed for each coding mode to select a coding mode having the minimum bitrate is disclosed. Furthermore, in Thomas Wiegand and Berand Girod, “Multi-frame motion compensated prediction for video transmission”, Kluwer Academic Publishers 2001, a fourth conventional technique in which a coding process is actually executed for each coding mode to calculate a bitrate, a distortion which is an error between a decoded image and an original image is calculated, and an optimum coding mode is selected based on the bitrate and the distortion is disclosed.

In JP-A No. 2000-102017, the following fifth conventional technique is disclosed. A 1-inter-field difference and a 2-inter-field difference of an input image are calculated, a frame structure is selected when the 1-inter-field difference is smaller than the 2-inter-field difference, and a field structure is selected when the 2-inter-field difference is smaller than the 1-inter-field difference.

However, in the first conventional technique and the second conventional technique, a coding mode is selected based on estimation or prediction. For this reason, when the estimation or prediction is wrong, the selected coding mode may not be appropriate even though a coding process is actually executed. Coding efficiency is actually deteriorated, and compression efficiency of moving picture coding may be deteriorated.

In contrast to this, in the third conventional technique or the fourth conventional technique, a coding mode is selected based on a bitrate obtained by actually executing a coding process. For this reason, coding having high coding efficiency can be performed.

However, in the third conventional technique or the fourth conventional technique, since a coding processing is actually executed for each selectable coding mode, coding efficiency is improved. In contrast to this, when there are a large number of coding modes, an amount of calculation and a hardware scale, which are required for coding are disadvantageously excessive. As a result, the production cost of an encoder increases.

The first to fourth conventional techniques are related to selection of coding modes in a macroblock. The first to fourth conventional techniques do not perform coding mode selection adapted to selection (frame-field determination in a macroblock pair) of a coding structure in an interlace-type moving picture.

On the other hand, the fifth conventional technique is related to selection of interlace-type coding structures. However, a difference in an input image is used as a reference. For this reason, when inter-frame coding is selected in an inter-frame coding picture or an inter-frame coding slice, coding efficiency is considerably deteriorated, and compression efficiency of a moving picture becomes deteriorated.

### SUMMARY OF THE INVENTION

According to one aspect of the present invention, an apparatus for coding a moving picture includes a prediction signal generating unit that generates a prediction signal for each coding mode from an input image and a reference image to generate a prediction error signal indicating a difference between a signal of the input image and the prediction signal, the input image being obtained from an interlaced moving picture; a candidate mode selecting unit that calculates a first coding cost based on the prediction error signal for each coding mode to select a candidate coding mode based on the first coding cost; a tentative coding unit that calculates a bitrate for each coding mode by performing a part of the coding on the prediction error signal for each first coding cost; a coding mode control unit that calculates a second coding cost based on the bitrate to determine a coding mode among candidate coding modes based on the second coding cost; a coding structure deciding unit that decides one of frame coding structure and field coding structure based on the second coding cost; and a coding unit that performs coding according to the determined coding mode on the prediction error signal with the decided coding structure.

According to another aspect of the present invention, an apparatus for coding a moving picture includes an adaptive mode selecting unit that selects at least one coding mode in which a coding is performed based on a type of an input image obtained from an interlaced moving picture; a prediction unit that generates a prediction signal for each selected coding mode from the input image and a reference image to generate a prediction error signal indicating a difference between a signal of the input image and the prediction signal for each coding mode; a tentative coding unit that performs a part of the coding on the prediction error signal for each selected coding mode to calculate a bitrate for each coding mode; a coding mode control unit that calculates a coding cost based on the bitrate to determine a coding mode among the selected coding modes based on the coding cost; a coding structure deciding unit that decides one of frame coding structure and field coding structure based on the coding cost; and a coding unit that performs coding according to the determined coding mode on the prediction error signal with the decided coding structure.

According to still another aspect of the present invention, an apparatus for coding a moving picture includes a prediction unit that generates a prediction signal for each coding mode from an input image obtained from an interlaced moving picture, and a reference image to generate a prediction error signal indicating a difference between a signal of the input image and the prediction signal for each coding mode; a coding cost calculating unit that calculates a coding cost for each coding mode based on the prediction error signal; a coding mode control unit that determines the coding mode based on the coding cost; a coding structure deciding unit that decides one of frame coding structure and field coding structure based on the coding cost; and a coding unit that performs coding according to the determined coding mode on the prediction error signal with the decided coding structure.

According to still another aspect of the present invention, an apparatus for coding a moving picture includes a prediction unit that generates a prediction signal for each coding mode from an input image obtained from an interlaced moving picture, and a reference image to generate a prediction error signal indicating a difference between a signal of the input image and the prediction signal for each coding mode; a tentative coding unit that performs a part of the coding on the prediction error signal for each coding mode to calculate a bitrate for each coding mode; a coding mode control unit that calculates a coding cost based on the bitrate to determine the coding mode based on the coding cost; a coding structure deciding unit that decides one of frame coding structure and field coding structure based on the coding cost; and a coding unit that performs coding according to the determined coding mode on the prediction error signal with the decided coding structure.

### BRIEF DESCRIPTION OF THE DRAWINGS

FIG. 1 is a block diagram showing a functional configuration of a moving picture coding apparatus 100 according to the first embodiment;

FIG. 2 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the first embodiment;

FIG. 3 is a diagram for explaining an example of a coding mode;

FIG. 4 is a flow chart showing a procedure of all processes of moving picture coding according to the first embodiment;

FIG. 5 is a flow chart showing a procedure of a tentative coding process and a coding process according to the first embodiment;

FIG. 6 is a block diagram showing functional configurations of a first frame tentative coding unit 111, a second frame tentative coding unit,112, a first field tentative coding unit 113, a second field tentative coding unit 114, a first frame coding unit 131, a second frame coding unit 132, a first field coding unit 133, and a second field coding unit 134 according to-the second embodiment;

FIG. 7 is a flow chart showing procedures of a tentative coding process and a coding process according to the second embodiment;

FIG. 8 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the third embodiment;

FIG. 9 is a flow chart showing procedures of a tentative coding process and a coding process according to the third embodiment;

FIG. 10 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the fourth embodiment;

FIG. 11 is a flow chart showing procedures of a tentative coding process and a coding process according to the fourth embodiment;

FIG. 12 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the fifth embodiment;

FIG. 13 is a flow chart showing procedures of a tentative coding process and a coding process according to the fifth embodiment;

FIG. 14 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the sixth embodiment;

FIG. 15 is a flow chart showing procedures of a tentative coding process and a coding process according to the sixth embodiment;

FIG. 16 is a block diagram showing functional configurations of a first frame tentative coding unit 111, a second frame tentative coding unit 112, a first field tentative coding unit 113, and a second field tentative coding unit 114 according to the seventh embodiment;

FIG. 17 is a flow chart showing procedures of a tentative coding process and a coding process according to the seventh embodiment;

FIG. 18 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134 according to the eighth embodiment; and

FIG. 19 is a flow chart showing procedures of a tentative coding process and a coding process according to the eighth embodiment.

### DETAILED DESCRIPTION OF THE PREFERRED EMBODIMENTS

Preferred embodiments of a moving picture coding apparatus and a computer product according to the present invention will be described below in detail with reference to the accompanying drawings.

In a moving picture coding apparatus according to the first embodiment, a first coding cost for each coding mode is calculated based on an input interlace-type image signal, and coding modes serving as candidates are selected in ascending order of first coding costs. Tentative coding based on an image signal is performed in the selected coding mode to calculate a second coding cost, and a coding mode having the minimum second coding cost is employed to select a frame coding structure or a field coding structure, so that a coding process is performed.

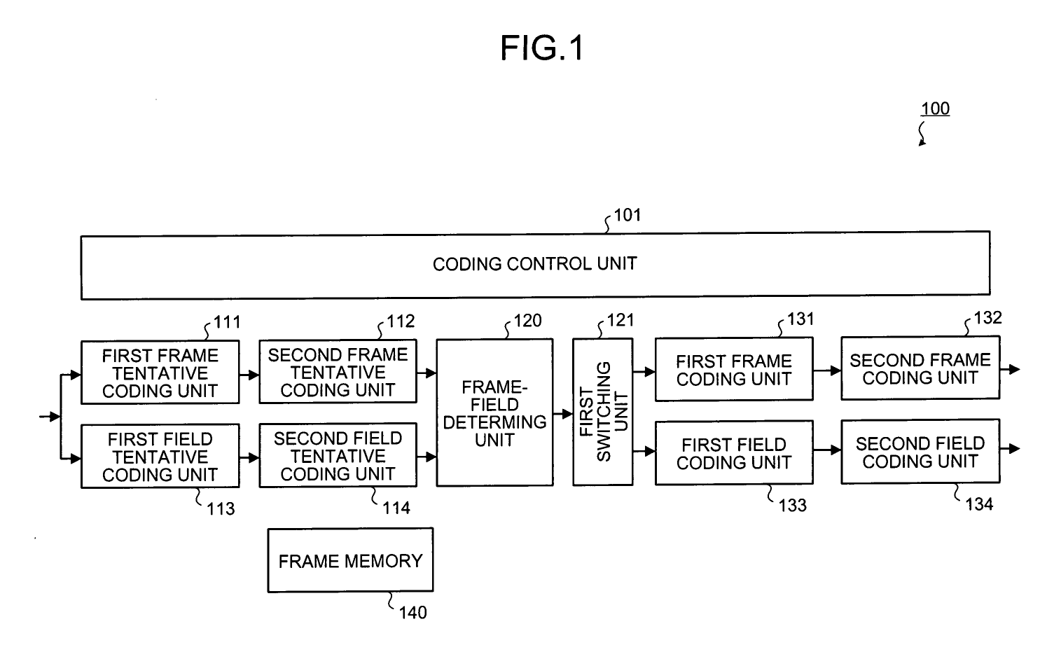

FIG. 1 is a block diagram showing a functional structure of a moving picture coding apparatus 100 according to the first embodiment. The moving picture coding apparatus 100, as shown in FIG. 1, has a configuration which mainly includes a coding control unit 101, a first frame tentative coding unit 111, a second frame tentative coding unit 112, a first field tentative coding unit 113, a second field tentative coding unit 114, a frame-field determining unit 120, a first switching unit 121, a first frame coding unit 131, a second frame coding unit 132, a first field coding unit 133, a second field coding unit 134, a frame-field determining unit 120, and a frame memory.

The coding control unit 101 performs switching control of coding modes of a moving picture. The coding mode determines a method of an image coding process. In the moving picture coding apparatus according to the embodiment, a method determined by international standards defined by H. 264 is employed. A concrete example of the coding mode will be described later. The coding control unit 101 performs a process of deciding whether tentative coding or coding is performed to set a coding flag. In this case, the coding control unit 101 sets the coding flag at 0 when the tentative coding is performed. When the coding is performed, the coding flag is set at 1. More specifically, the coding control unit 101 sets the coding flags at 0 for the first frame tentative coding unit 111, the second frame tentative coding unit 112, the first field tentative coding unit 113, and the second field tentative coding unit 114. The coding control unit 101 sets the coding flags at 1 for the first frame coding unit 131, the second frame coding unit 132, the first field coding unit 133, and the second field coding unit 134.

In the moving picture coding apparatus 100 according to the embodiment, an input image signal to be coded is divided into a macroblock pair. Each macroblock pair is input to the first frame tentative coding unit 111 and the first field tentative coding unit 113, and a tentative coding process by a frame coding structure and a tentative coding process by a field coding structure are executed in parallel to each other.

For images of the input macroblock pair, the first frame tentative coding unit 111 generates a prediction signal and a prediction error signal by coding processes performed in coding modes under frame coding structures about image signals of an Upper macroblock constituting an interlace image to calculate a first coding cost, so that coding modes are selected as candidates. The first frame tentative coding unit 111 performs tentative coding to the prediction error signal to calculate a second coding cost which is a value serving as a measure of an amount of coding process and determines the coding mode having the minimum second coding cost selected from the coding modes serving as the candidates. In this case, the tentative coding is a process which performs orthogonal transformation and quantization to the prediction error signal and then performs Huffman coding or the like without generating coding data.

For images of the input macroblock pair, the second frame tentative coding unit 112 generates a prediction signal and a prediction error signal by coding processes performed in coding modes under frame coding structures about image signals of a Lower macroblock constituting an interlace image to calculate a first coding cost, so that coding modes are selected as candidates. The second frame tentative coding unit 112 performs tentative coding to the prediction error signal to calculate the second coding cost and determines the coding mode having the minimum second coding cost selected from the coding modes serving as the candidates.

For images of the input macroblock pair, the first field tentative coding unit 113 generates a prediction signal and a prediction error signal by coding processes performed in coding modes under field coding structures about image signals of a Top macroblock constituting an interlace image to calculate a first coding cost, so that coding modes are selected as candidates. The first field tentative coding unit 113 performs tentative coding to the prediction error signal to calculate the second coding cost and determines the coding mode having the minimum second coding cost selected from the coding modes serving as the candidates.

For images of the input macroblock pair, the second field tentative coding unit 114 generates a prediction signal and a prediction error signal by coding processes performed in coding modes under field coding structures about image signals of a Bottom macroblock constituting an interlace image to calculate a first coding cost, so that coding modes are selected as candidates. The second field tentative coding unit 114 performs tentative coding to the prediction error signal to calculate the second coding cost and determines the coding mode having the minimum second coding cost selected from the coding modes serving as the candidates.

The frame-field determining unit 120 calculates a second coding cost (to be described later) of an image having a frame coding structure and a second coding cost (to be described later) of an image having a field coding structure to determine a coding structure having a small cost. More specifically, the frame-field determining unit 120 performs the following process. That is, a frame coding cost which is a sum of the second coding cost of the Upper macroblock having the field coding structure and the second coding cost of the Lower macroblock having the field coding structure is calculated, and a field coding cost which is a sum of the second coding cost of the Top macroblock having the field coding structure and the second coding cost of the Bottom macroblock having the field coding structure is calculated. The frame coding cost is compared with the field coding cost, and employment of a coding structure having a small coding cost is determined.

The first switching unit 121 performs connection switching as follows. That is, an output of the second frame tentative coding unit 112 is connected to the first frame coding unit 131 when the frame coding structure is determined by the frame-field determining unit 120. When the field coding structure is determined in the frame-field determining unit 120, an output of the second field tentative coding unit 114 is connected to the first frame coding unit 131.

The first frame coding unit 131 performs a coding process of the coding mode determined to the image signal of the Upper macroblock under the frame coding structure.

The second frame coding unit 132 performs a coding process of the coding mode determined to the image signal of the Lower macroblock under the frame coding structure.

The first field coding unit 133 performs a coding process of the coding mode determined to the image signal of the Top macroblock under the field coding structure.

The second field coding unit 134 performs a coding process of the coding mode determined to the image signal of the Bottom macroblock under the field coding structure.

A frame memory 140 temporarily holds a reference image generated by performing a decoding process to a signal obtained by coding an input image signal.

The coding control unit 101 determines whether coding or tentative coding is performed to the input moving picture signal, performs switching designation to a second switching unit (to be described later), and performs a switching process of various coding modes.

The first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134 will be described below.

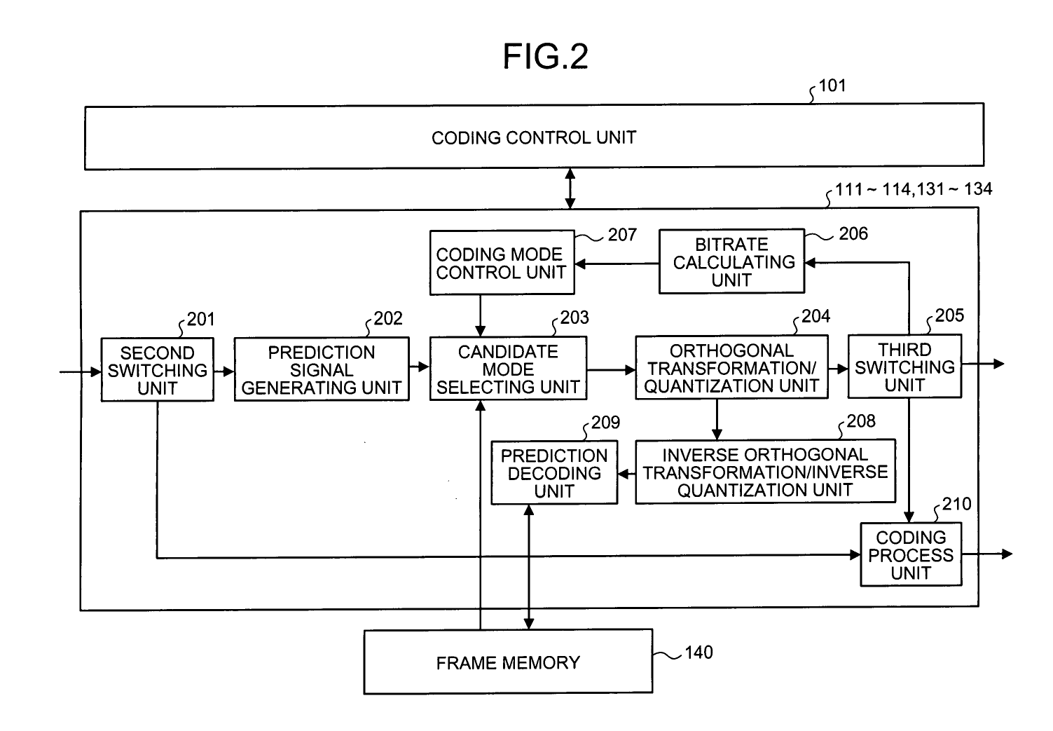

FIG. 2 is a block diagram showing functional configurations of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 2, mainly includes a second switching unit 201, a prediction signal generating unit 202, a candidate mode selecting unit 203, an orthogonal transformation/quantization unit 204, a third switching unit 205, a bitrate calculating unit 206, a coding mode control unit 207, an inverse transformation/inverse quantization unit 208, a prediction decoding unit 209, and a coding process unit 210.

The second switching unit 201 performs the following process. That is, an image signal of a macroblock to be input is output to the prediction signal generating unit 202 when it is determined by the coding control unit 101 that a tentative coding process is performed, and an image signal of a macroblock to be input is output to the coding process unit 210 when it is determined by the coding control unit 101 that a coding process is performed.

In the first frame tentative coding unit 111, the second frame tentative coding unit 112, the first field tentative coding unit 113, and the second field tentative coding unit 114 (hereinafter referred to as a “tentative coding unit”), the second switching unit 201 is designed to output the image signal of the macroblock to be input to the prediction signal generating unit 202. In the first frame coding unit 131, the second frame coding unit 132, the first field coding unit 133, and the second field coding unit 134 (hereinafter referred to as a “coding unit”), the second switching unit 201 is designed to output the image signal of the macroblock to be input and coding information such as an orthogonal transformation coefficient and a prediction error signal calculated by the first frame tentative coding unit 111, the second frame tentative coding unit 112, the first field tentative coding unit 113, and the second field tentative coding unit 114 to the coding process unit 210. In this manner, in the coding process unit 210, a coding process is performed in the coding mode determined by the tentative coding unit to the image signal of the macroblock to be input.

In the coding control unit 101, as coding modes of Intra-frame prediction coding and Inter-frame prediction coding performed by a prediction signal generating unit 200, a plurality of different coding modes are determined in advance depending on the size of a macroblock, a prediction signal generating method, and the like, and any coding mode is set by the coding mode control unit 207.

The prediction signal generating unit 202 generates a prediction signal by the coding process method determined by the coding mode by using a reference image temporarily stored in the frame memory 140 in coding modes sequentially set by the coding mode control unit 207. The prediction signal generating unit 202 generates a prediction error signal which is a pixel difference between the image signal of the input macroblock and the generated prediction signal. When the set coding mode is a mode related to the inter-frame prediction coding, the prediction signal generating unit 202 also detects a motion vector to perform motion compensation. The prediction signal generating unit,200 may generate prediction signals for all the respective coding modes corresponding to macroblocks to be processed or may generate prediction signals for only some coding modes of the coding modes corresponding to the macroblocks to be processed.

The candidate mode selecting unit 203 calculates a first coding cost representing an amount of coding process obtained by the coding mode based on prediction signals set in the coding modes generated by the prediction signal generating unit 202, and selects coding modes corresponding to N (N: integer) values in ascending order of first coding costs as coding modes serving as candidates.

In this case, the first coding cost is calculated by Equation (1):
Cost=SAD+λ×OH (1)
where SAD is an intra-macroblock pixel accumulation value of a prediction error signal, and λ is a constant. OH denotes a predetermined bitrate of mode information when a present coding mode is selected, corresponds to, for example, a distance or the like of a motion vector.

The candidate mode selecting unit 203 reduces the number of processes passing through subsequent tentative coding loops (orthogonal transformation/quantization unit 204→bitrate calculating unit 206→coding mode control unit 207). More specifically, when there are a plurality of coding modes of a macroblock predicted by the prediction signal generating unit 202, in order to reduce the number of processes having processing load on the bitrate calculating unit 206, the orthogonal transformation/quantization unit 204, and the like, the candidate mode selecting unit 203 selects coding modes serving as candidates from all the coding modes.

Since the first coding cost is calculated from a prediction error signal, the calculation can be executed at a speed, which is considerably higher than that of the process in the orthogonal transformation/quantization unit 204 or the bitrate calculating unit 206. Therefore, the candidate mode selecting unit 203 narrows down the candidates of the coding modes to a mode having a small prediction error signal to make it possible to rapidly and appropriately realize a decision of a macroblock having a frame coding structure and a macroblock having a field coding structure.

The orthogonal transformation/quantization unit 204 performs orthogonal transformation (for example, discrete cosine transformation, integer transformation, or the like) to a prediction error signal in each coding mode serving as a candidate to quantize the transformation coefficient, and outputs the quantized orthogonal transformation coefficient and information (or, additionally, information of a motion vector) of the coding mode to the third switching unit 205 and the inverse transformation/inverse quantization unit 208.

The third switching unit 205 switches the orthogonal transformation coefficient, the information of the coding mode, and the like output from the orthogonal transformation/quantization unit 204 to an output to the bitrate calculating unit 206, an output to the outside of the tentative coding unit/coding unit, and an output to the coding process unit 210.

More specifically, in the tentative coding unit, when a coding mode is not determined, the third switching unit 205 performs a switching operation such that the orthogonal transformation coefficient, the information of the coding mode, and the like are output to the bitrate calculating unit 206. When the coding mode is determined, the third switching unit 205 performs a switching operation such that the orthogonal transformation coefficient, the information of the coding mode, and the like are output to the outside of the tentative coding unit/coding unit. In the tentative coding unit, when only one coding mode serving as a candidate is selected by the candidate mode selecting unit 203 (more specifically, when N=1 is satisfied), the orthogonal transformation coefficient, a switching operation is performed to output the information of the coding mode, and the like to the coding process unit 210.

The bitrate calculating unit 206 temporarily codes a signal input from the third switching unit 205 and representing the orthogonal transformation coefficient and the information of the motion vector and measures a bitrate without outputting the coding data. In this case, in the embodiment, a bitrate obtained when entropy coding based on Huffman coding or arithmetic coding, and do not output entropy coding data.

The coding mode control unit 207 performs a process of setting a coding mode in the candidate mode selecting unit 203. In the candidate mode selecting unit 203, a prediction error signal output from the prediction signal generating unit 202 is controlled in response to the coding mode set by the coding mode control unit 207.

The coding mode control unit 207 calculates a second coding cost serving as a reference of an amount of coding process from the bitrate output from the bitrate calculating unit 206 and determines a coding mode having the minimum second coding cost as a coding mode employed as a coding process.

More specifically, the coding mode control unit 207 when an output is connected to the bitrate calculating unit 206 in the third switching unit 205, sequentially set an executable coding mode or a plurality of coding modes in the candidate mode selecting unit 203. The coding mode control unit 207 calculates second coding costs in the respective coding modes from the bitrate of the coding modes calculated in the bitrate calculating unit 206 and to determine a coding mode having the minimum second coding cost.

More specifically, for a macroblock to be coded, in the respective coding modes serving as candidates, prediction coding and measurement of a bitrate (the processes in the candidate mode selecting unit 203→the orthogonal transformation/quantization unit 204→the third switching unit 205→the bitrate calculating unit 206 o the coding mode control unit 207 in the order named) are executed. The second coding costs based on the bitrate calculated in the respective coding modes are compared with each other, so that a coding mode having the minimum value is selected.

The inverse orthogonal transformation/inverse quantization unit 208 inversely quantizes the orthogonal transformation coefficient quantized by the orthogonal transformation/quantization unit 204 to restore an orthogonal transformation coefficient. The inverse orthogonal transformation/inverse quantization unit 208 performs an inverse orthogonal transformation process (for example, inverse discrete cosine transformation, inverse integer transformation, and the like) to the restored orthogonal transformation coefficient to restore a prediction error signal or the like, and outputs the restored prediction error signal to the prediction decoding unit 209.

The prediction decoding unit 209 generates a prediction signal from the prediction error signal and stores an image restored from the prediction signal in the frame memory 140 as a reference image. The reference image stored in the frame memory 140 is referred to in the processes of generating the prediction signal and the prediction error signal performed by the prediction signal generating unit 202.

The coding process unit 210 performs entropy coding to the orthogonal transformation coefficient and the coding information obtained and quantized by the orthogonal transformation/quantization unit 204 in the coding mode determined by the tentative coding unit and outputs coding data outside.

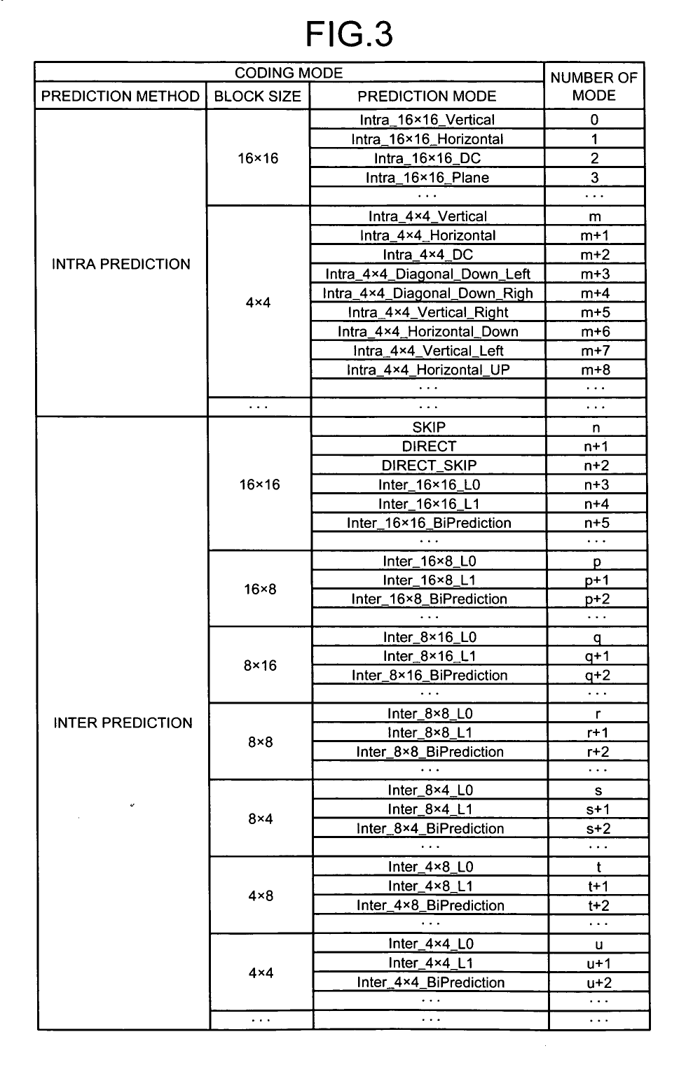

Coding modes used in the moving picture coding apparatus 100 will be described below. The coding mode is determined by H. 264, which is one of international standards. The coding mode is determined by a combination of a prediction method, a block size, a prediction mode, and the like. FIG. 3 is a diagram for explaining an example of the coding mode. As shown in FIG. 3, the coding modes are determined by combinations of prediction methods, block sizes, and prediction modes. Mode numbers are associated with the modes, respectively.

As shown in FIG. 3, in H. 264, as the coding methods, Intra-frame prediction coding and Inter-frame prediction coding are known. In the Intra-frame prediction coding, coding for respective macroblock units using 4×4 pixels and 16×6 pixels as block sizes can be performed. In the Intra-frame prediction coding in 4×4 pixel units, depending on differences of prediction directions from a reference pixel to pixels to be coded, the prediction modes can be classified into 9 types of prediction modes, i.e., Vertical prediction, Horizontal prediction, DC prediction, Diagonal Down Left prediction, Diagonal Down right prediction, Vertical Right prediction, Horizontal Down prediction, Vertical Left prediction, and Horizontal Up prediction. In the Intra-frame prediction coding in 16×16 pixel units, depending on the differences of prediction directions, the prediction modes can be classified into 4 types of prediction modes, i.e., Vertical prediction, Horizontal prediction, DC prediction, and Plane prediction.

On the other hand, in the Inter-frame prediction coding, as shown in FIG. 3, coding using macroblock units having 16×16 pixels, 16×8 pixels, 8×16 pixels, and 8×8 pixels as block sizes. When macroblocks of 8×8 pixels are used, in addition to coding using macroblock units having 8×8 pixels as block sizes, coding using macroblock units having 8×4 pixels, 4×8 pixels, and 4×4 pixels as block sizes. That is, there are seven types of inter-frame prediction coding as classified by block size. With respect to the Inter-frame prediction coding using the block sizes as units, prediction modes including Forward prediction (indicated by L0 in FIG. 3), Backward prediction (indicated by L1 in FIG. 3), and BirePrediction (indicated by BiPrediction in FIG. 3) are known.

When a macroblock using 16×16 pixels, a skipped macroblock mode (indicated by SKIP in FIG. 3), a block mode (indicated by DIRECT in FIG. 3) serving as a coding mode which predictively generates motion information from motion information of a coded block, and a coding mode (indicated by DIRECT SKIP in FIG. 3) which uses both the skipped macroblock mode and the block mode are known.

The coding modes shown in FIG. 3 are only examples. As other prediction modes, other modes other than prediction methods and reference methods can be added and changed.

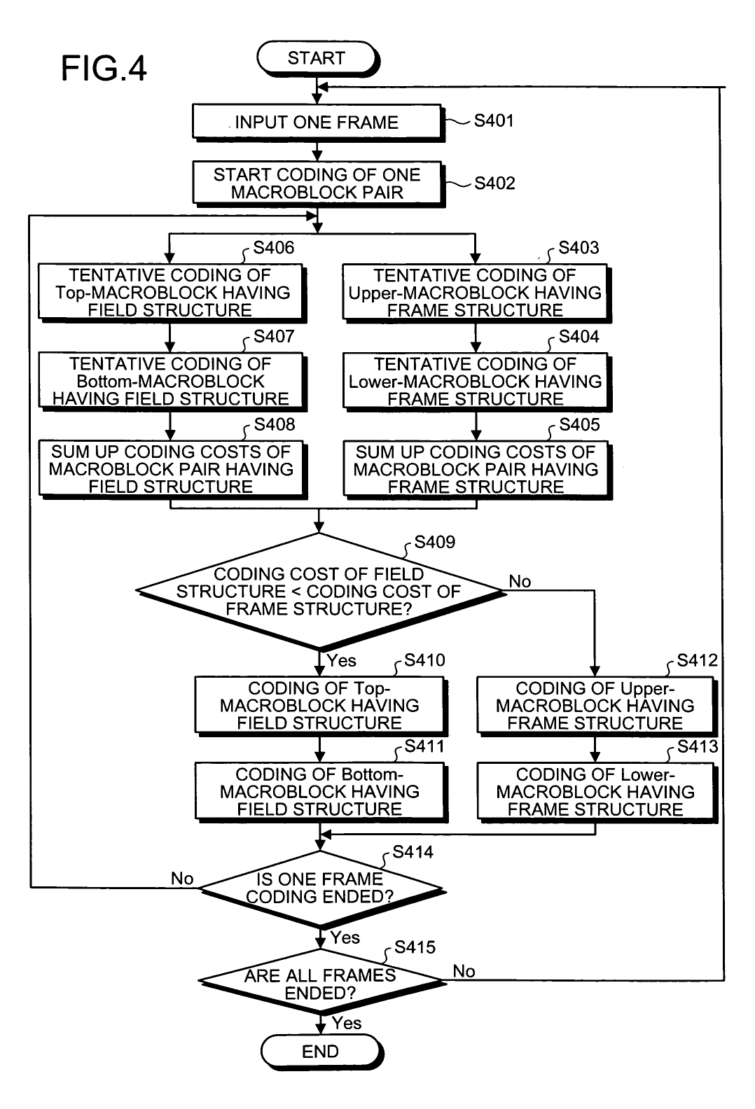

Moving picture coding processes in the moving picture coding apparatus according to the embodiment arranged as described above will be described below. FIG. 4 is a flow chart of a procedure of all processes of moving picture coding in the moving picture coding.

In the moving picture coding apparatus 100 according to the embodiment, when moving picture signals are input for respective frames (step S401), the input image signal of one frame is divided into macroblocks, and a coding process is started for each macroblock pair constituting an interlace image (step S402). At this time, the image signals of the macroblocks are input to the first frame tentative coding unit 111 and the first field tentative coding unit 113. A tentative coding process under a frame coding structure constituted by the first frame tentative coding unit 111 and the second frame tentative coding unit 112 and a tentative coding process under a field coding structure constituted by the first field tentative coding unit 113 and the second field tentative coding unit 114 are executed to the image signals in parallel to each other.

The first frame tentative coding unit 111 performs a tentative coding process to an Upper macroblock of the input macroblock pair in a frame coding structure (step S403). The second frame tentative coding unit 112 performs a tentative coding process to a Lower macroblock of the input macroblock pair in the frame coding structure (step S404).

In this case, a second coding cost to the Upper macroblock is calculated by the tentative coding performed by the first frame tentative coding unit 111, and a second coding cost to the Lower macroblock is calculated by the tentative coding performed by the second frame tentative coding unit 112. The processes in the first frame tentative coding unit 111 and the second frame tentative coding unit 112 will be described later.

The frame-field determining unit 120 sums up the second coding cost to the Upper macroblock and the second coding cost to the Lower macroblock (step S405) and sets the summed-up cost as a frame coding cost.

In parallel to the processes in steps S403 to S405, the first field tentative coding unit 113 performs a tentative coding process to a Top macroblock of the input macroblock pair in a field coding structure (step S406). The second field tentative coding unit 114 performs a tentative coding process to a Bottom macroblock of the input macroblock pair in the field coding structure (step S407).

A second coding cost to the Top macroblock is calculated by tentative coding performed by the first field tentative coding unit 113, and a second coding cost to the Bottom macroblock is calculated by tentative coding performed by the second field tentative coding unit 114. The processes in the first field tentative coding unit 113 and the second field tentative coding unit 114 will be described below.

The frame-field determining unit 120 sums up the second coding cost to the Top macroblock and the second coding cost to the Bottom macroblock (step S408) and sets the summed-up cost as a frame coding cost.

The frame-field determining unit 120 compares the frame coding cost with the field coding cost and decides whether the field coding cost is smaller than the frame coding cost (step S409).

When the field coding cost is smaller than the frame coding cost (step S409: Yes), the frame-field determining unit 120 determines the field coding structure as the coding structure and switches an output terminal to the first field coding unit 133. The first field coding unit 133 codes the Top macroblock of a macroblock pair constituting an interlace image in the field coding structure (step S410). The second field coding unit 134 codes the Bottom macroblock in the field coding structure (step S411) to output coded data.

On the other hand, in step S409, when the frame coding cost is higher than the field coding cost (step S409: No), the frame-field determining unit 120 determines the frame coding structure as the coding structure, and the first switching unit 121 switches the output terminal to the first frame coding unit 131. The first frame coding unit 131 codes the Upper macroblock of the macroblock pair constituting the interlace image in the frame coding structure (step S412). The second frame coding unit 132 codes the Lower macroblock in the frame coding structure (step S413) to output coded data.

The processes in steps S403 to S413 to the macroblocks are executed to all macroblocks of one frame (step S414). Process in steps S401 to S414 to one frame are executed to all the frames (step S415).

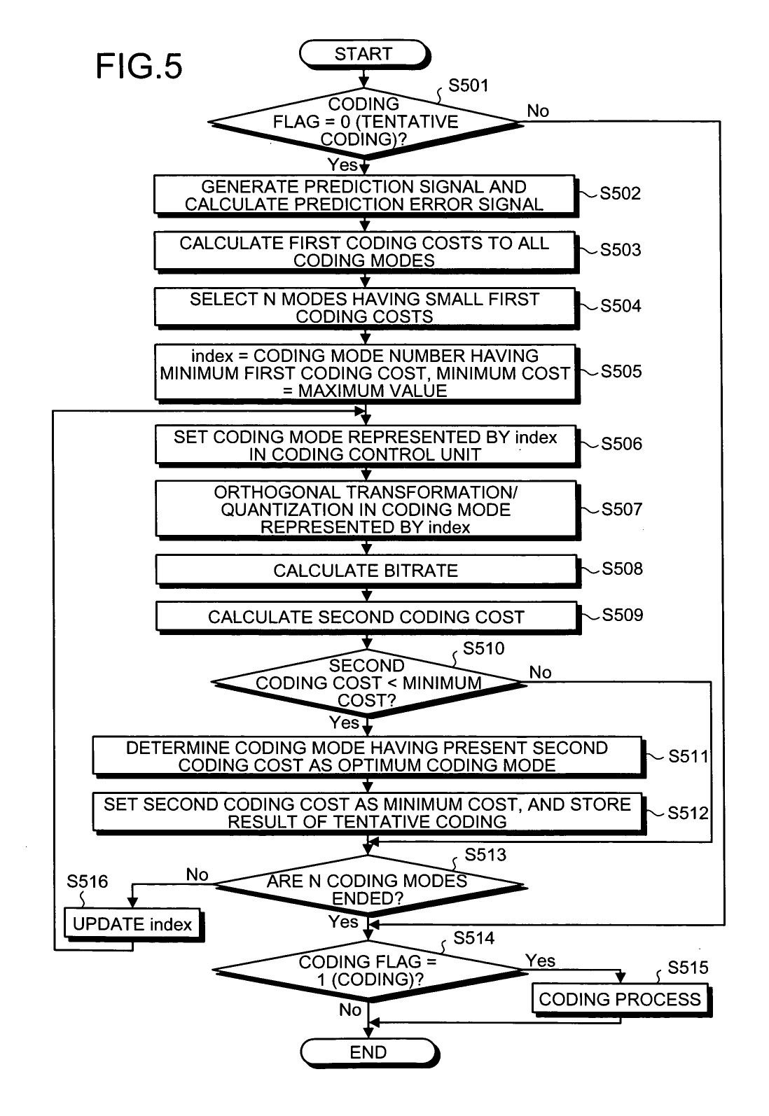

The tentative coding processes in steps S403, S404, S406, and S407 and the coding processes in step S410, S411, S412, and S413 will be described below in detail. FIG. 5 is a flow chart showing a procedure of the tentative coding processes and the coding processes.

When moving picture signals are input for respective macroblocks, coding of the input images is started for respective macroblocks. The second switching unit 201 refers to a coding flag set by the coding control unit 101 to check whether the coding flag is 0 or not to decide whether tentative coding is performed or not (step S501).

In this case, processes related to the first frame tentative coding unit 111, the second frame tentative coding unit 112, the first field tentative coding unit 113, and the second field tentative coding unit 114 will be described below. When image signals are input to the first frame tentative coding unit 111, the second frame tentative coding unit 112, the first field tentative coding unit 113, and the second field tentative coding unit 114, a coding flag is set at 0 to perform tentative coding (step S501: Yes). The second switching unit 201 switches the output terminal to a prediction signal generating unit 102 and outputs image signals of the input macroblocks to the prediction signal generating unit 102.

In the prediction signal generating unit 102, prediction signals are generated from the image signals of the input macroblocks according to a coding process method by all coding modes which can process the macroblocks to calculate a prediction error signal which is a pixel difference between the prediction signal and an input image signal (step S502). In this case, the prediction signal and the prediction error signal are generated in each of all the coding modes, which can process the input macroblocks.

The candidate mode selecting unit 203 calculates a first coding cost, from the prediction error signal generated by the prediction signal generating unit 202, by using Equation (1) in each of all the coding modes which can process the input macroblocks (step S503). The candidate mode selecting unit 203 sequentially selects N coding modes as coding modes serving as candidates from the calculated first coding costs of the coding modes in ascending order of values (step S504).

The coding mode control unit 207 initializes an index representing a number of a coding mode by setting a mode number of a coding mode having the minimum first coding cost in te coding modes selected by the candidate mode selecting unit 203 and initializes the minimum cost by a maximum value which is an arbitrary value (step S505).

The coding mode control unit 207 sets the coding modes of the mode number represented by the index value in the coding control unit 101 in a state in which an output of the third switching unit 205 is connected to the bitrate calculating unit 206 (step S506). In this manner, an orthogonal transformation process and a quantization process corresponding to the coding mode of the mode number represented by the index value are performed by the orthogonal transformation/quantization unit 204 (step S507). More specifically, the orthogonal transformation/quantization unit 204 orthogonally transforms a prediction error signal to quantize an orthogonal transformation coefficient.

On the other hand, the processes are performed, the quantized orthogonal transformation coefficient of the prediction error signal is input to the inverse orthogonal transformation/inverse quantization unit 208 and subjected to inverse quantization/inverse orthogonal transformation to reproduce the prediction error signal. The prediction decoding unit 209 generates a local decode image to temporarily store the local decide image in the frame memory 140 as a reference image. The generation of the reference image is performed to only coding modes serving as candidates.

The bitrate calculating unit 206 calculates a bitrate when entropy coding based on Huffman coding or arithmetic coding is performed to a quantized orthogonal transformation coefficient and information of a motion vector (step S508). However, entropy-coded data is not output.

The coding mode control unit 207 calculates a second coding cost from the calculated a bitrate (step S509). In the embodiment, as the second coding cost, the bitrate itself is used. However, the second coding cost is not limited to the bitrate.

The coding mode control unit 207 decides whether the calculated second coding cost is smaller than the minimum cost or not (step S510). When the second coding cost is smaller than the minimum cost (step S510: Yes), the coding mode control unit 207 determines a coding mode corresponding to the present second coding cost as an optimum coding mode (step S511). The minimum cost is updated with the present second coding cost, and a result of the tentative coding, i.e., coded data generated by a coding process in the coding mode corresponding to the mode number represented by the index is held in the frame memory 140 (step S512).

The coding mode control unit 207 decides whether processes to the N coding modes serving as candidates is ended or not (step S513). When the processes to the N coding modes is not ended (step S513: No), the index is updated with a mode number of a coding mode having the next small first coding cost in the coding modes selected as candidates (step S516), and the processes in steps S506 to S512 are repeatedly executed. In this manner, the coding mode having the minimum second coding cost is determined.

On the other hand, in step S513, when processing to the N coding modes serving as candidates is ended (step S513: Yes), the third switching unit 205 checks whether the coding flag is 1 or not to decide whether coding is performed or not (step S514). When the coding flag is 1 (coding is performed) (step S514: Yes), the third switching unit 205 switches the output terminal to connect the output terminal to the coding process unit 210, and a coding process is performed in the optimum coding mode determined by the coding mode control unit 207 (step S515). In this manner, the coding process is performed by any one of the first frame coding unit 131, the second frame coding unit 132, the first field coding unit 133, and the second field coding unit 134. On the other hand, in step S514, when the coding flag is set at 0, the third switching unit 205 switches the output terminal to connect the output terminal to an external circuit, and the process is ended. In this manner, the second coding cost of the optimum coding mode is output to any one of the first frame tentative coding unit 111, the second frame tentative coding unit 112, the first field tentative coding unit 113, and the second field tentative coding unit 114.

Returning to step S501, when the coding flag is 1 (step S501: No), the processes in steps S502 to S513 are not performed to calculate a second coding cost. In the first frame coding unit 131, the second frame coding unit 132, the first field coding unit 133, and the second field coding unit 134 since the coding flag is set at 1 to perform coding, No is determined in step S501.

In the moving picture coding apparatus according to the embodiment, when an interlace-type moving picture is to be coded, the number of modes is reduced by selecting coding modes having small first coding costs calculated by a prediction error signal of an input image signal as coding modes serving as candidates. Tentative coding process is performed to the selected coding mode, and a coding mode having the minimum second coding cost calculated from a bitrate of coding data in the coding modes is determined as a coding mode in which a coding process is performed. For this reason, coding having coding efficiency can be appropriately and accurately performed to make it possible to select the coding mode. For this reason, a preferable coding mode can be selected depending on the contents of macroblocks or the like. Since the number of coding modes in which tentative coding processes are actually performed is reduced, an amount of calculation can be considerably reduced, and load of the coding processes can be prevented from being increased.

In the moving picture coding apparatus 100 according to the first embodiment, the value itself of a bitrate is set as a second coding cost in the coding mode control unit, and a coding mode having the minimum second coding cost is determined as a coding mode used in a coding process. However, a moving picture coding apparatus 100 calculates a second coding cost from a bitrate and a distortion to determine a coding mode.

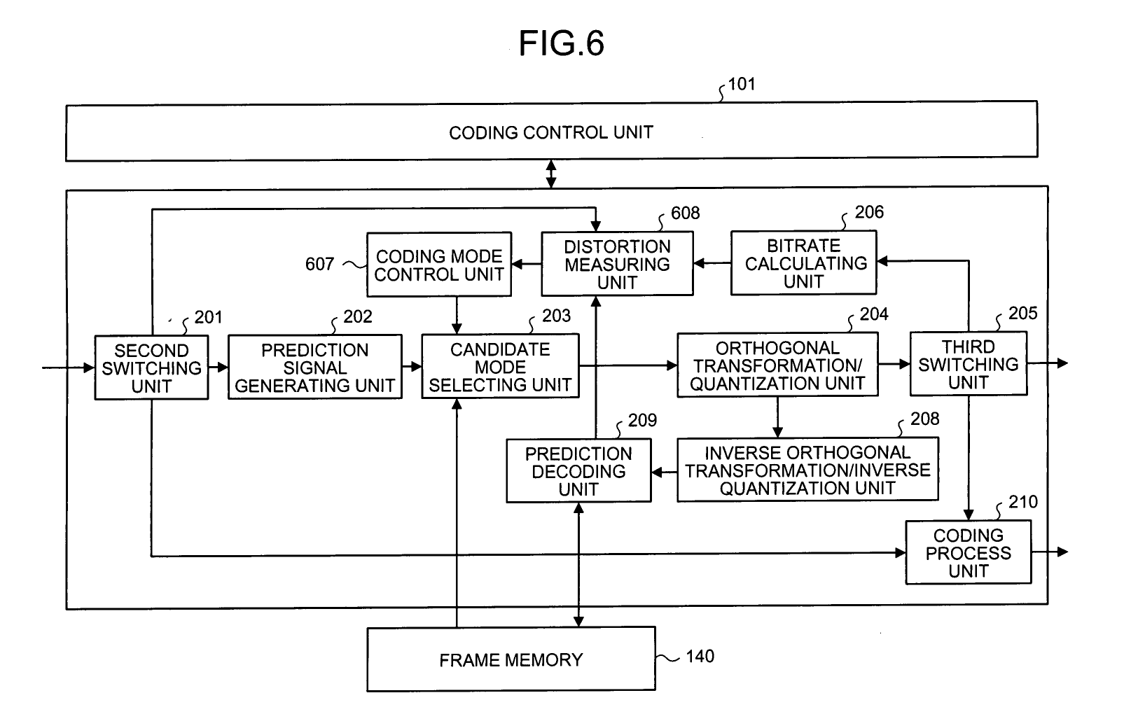

The functional configuration of the moving picture coding apparatus 100 according to the embodiment is the same as that of the moving picture coding apparatus according to the first embodiment shown in FIG. 1. FIG. 6 is a block diagram showing the functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 6, mainly includes a second switching unit 201, a prediction signal generating unit 202, a candidate mode selecting unit 203, an orthogonal transformation/quantization unit 204, a third switching unit 205, a bitrate calculating unit 206, a distortion measuring unit 608, a coding mode control unit 607, an inverse orthogonal transformation/inverse quantization unit 208, a prediction decoding unit 209, and a coding process unit 210.

In this case, the functions and configurations of the, second switching unit 201, the prediction signal generating unit 202, the candidate mode selecting unit 203, the orthogonal transformation/quantization unit 204, the third switching unit 205, the bitrate calculating unit 206, the inverse orthogonal transformation/inverse quantization unit 208, the prediction decoding unit 209, and the coding process unit 210 are the same as those in the first embodiment. Coding modes used in the moving picture coding apparatus 100 according to the second embodiment are the same as those in the first embodiment.

The distortion measuring unit 608 is to measure a distortion (for example, square error) which is an image difference between a reference image generated by the inverse orthogonal transformation/inverse quantization unit 208 and the prediction decoding unit 209 and temporarily stored in the frame memory 140 and an input image (original image obtained before coding) to be coded. In this case, the distortion is calculated in each of coding modes set by the coding mode control unit 607. More specifically, a distortion representing a difference between an image obtained by restoring an image processed and coded in each coding mode and the input image is measured.

The coding mode control unit 607 sequentially sets executable coding modes in the candidate mode selecting unit 203 in a state in which an output terminal of the third switching unit 205 is connected to the bitrate calculating unit 206, calculates a second coding cost serving as a reference of an amount of coding process to determine a coding mode in which a coding process is executed. More specifically, the coding mode control unit 607 digitizes the bitrates for the coding modes calculated by the bitrate calculating unit 206 when processes are performed for the coding modes and distortions for respective coding modes calculated by the distortion measuring unit 608 and adds both the values by Equation (2) to calculate second coding costs, so that a coding mode having the minimum second coding cost is determined.
Cost=D+λ×R (2)

Where D is a distortion, R is a bitrate, and λ is a constant.

In the embodiment, the second coding cost is defined as a value obtained by adding a bitrate and a distortion. However, as the second coding cost, not only the value but also a value based on the bitrate and the distortion can be used. In the digitization of the bitrate and the distortion, the bitrate may be emphasized, or the distortion may be emphasized, or one of the bitrate and the distortion may be determined by a user as a value to be emphasized.

A moving picture coding process in the moving picture coding apparatus 100 according to the embodiment arranged as described above will be described below. The same procedure (FIG. 4) as that of the first embodiment is performed with respect to all the processes of moving picture coding.

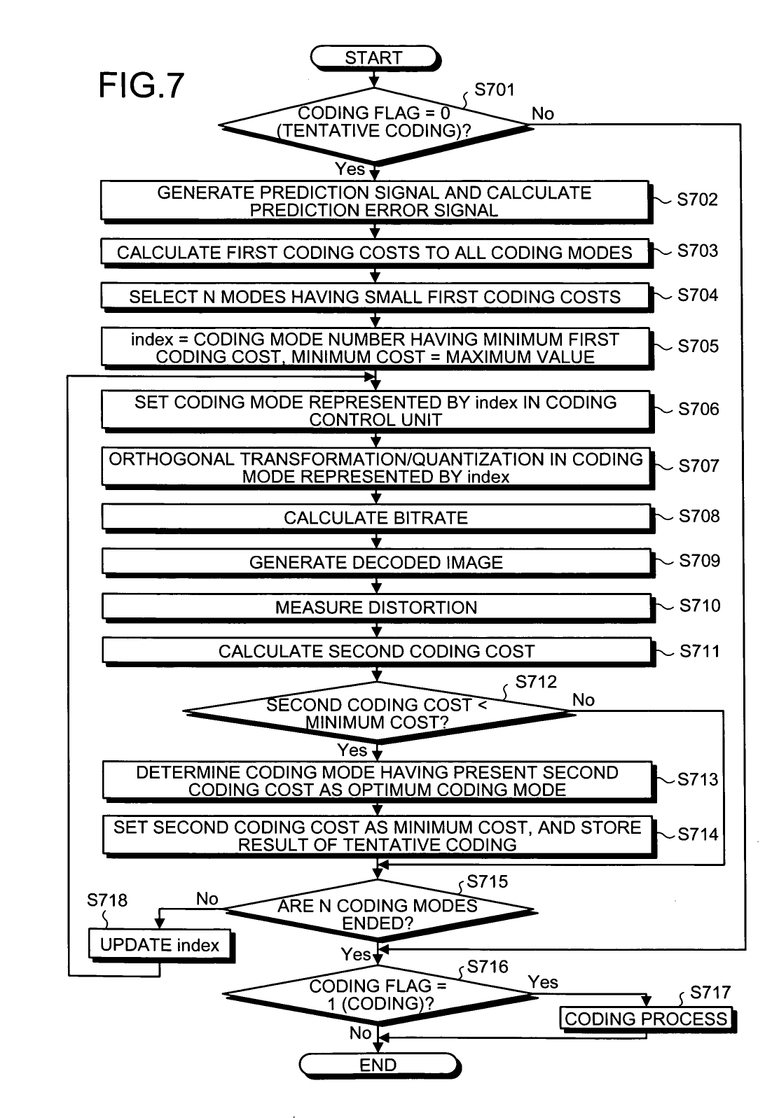

Tentative coding processes in steps S403, S404, S406, and S407 and coding processes in steps S410, S411, S412, and S413 in all the processes (FIG. 4) of moving picture coding will be described in detail. FIG. 7 is a flow chart showing a procedure of the tentative coding processes and the coding processes.

When moving picture signals are input for respective macroblocks, coding of the input images is started for respective macroblocks. The second switching unit 201 refers to a coding flag set by the coding control unit 101 to check whether the coding flag is set at 0 or not to decide whether tentative coding is performed or not (step S701).

Processes related to the first frame tentative coding unit 111, the second frame tentative coding unit 112, the first field tentative coding unit 113, and the second field tentative coding unit 114 will be described below. When image signals are input to the first frame tentative coding unit 111, the second frame tentative coding unit 112, the first field tentative coding unit 113, and the second field tentative coding unit 114, a coding flag is set at 0 to perform tentative coding (step S701: Yes). The second switching unit 201 switches the output terminal to a prediction signal generating unit 102 and outputs image signals of the input macroblocks to the prediction signal generating unit 102.

The processes (steps S702 to S708) in which generation of a prediction signal and a prediction error signal to calculation of a bitrate are performed in the same manner as that of the processes (steps S502 to S508) in the moving picture coding apparatus 100 according to the first embodiment.

The orthogonal transformation/quantization unit 204 orthogonally transforms a prediction error signal and quantizes an orthogonal transformation coefficient in step S707. In step S708, when a process of calculating a bitrate when entropy coding based on Huffman coding or arithmetic coding is performed to the quantized orthogonal transformation coefficient or the information of a motion vector is performed by the bitrate calculating unit 206, the quantized orthogonal transformation coefficient of the prediction error signal is input to the inverse orthogonal transformation/inverse quantization unit 208 and subjected to inverse quantization/inverse orthogonal transformation to reproduce a prediction error signal. The prediction decoding unit 209 generates a local decode image serving as a decoded image. The local decode image is temporarily stored in the frame memory 140 as a reference image (step S709). The generation of the reference image is performed for coding modes serving as candidates.

The distortion measuring unit 608 measures a distortion which is an image difference between the reference image in the frame memory 140 and an input image to be coded (original image obtained before coding) (step S710).

The coding mode control unit 607 calculates a second coding cost from the bitrate calculated in step S708 and the distortion measured in step S709 by using Equation (2).

The coding mode control unit 607 decides whether the calculated second coding cost is smaller than the minimum cost or not (step S712). When the second coding cost is smaller than the minimum cost (step S712: Yes), the coding mode control unit 607 determines a coding mode corresponding to the present second coding cost as an optimum coding mode (step S713). The minimum cost is updated with the present second coding cost, and a result of the tentative coding, i.e., coded data generated by a coding process for the coding mode corresponding to the mode number represented by the index is held in the frame memory 140 (step S714).

Subsequently, as in the first embodiment, the processes in steps S706 to S714 are repeatedly executed to N coding modes serving as candidates (step S715), so that a coding mode having the minimum second coding cost is determined.

The processes are executed to the N coding modes serving as candidates to determine the coding mode having the minimum second coding cost, as in the first embodiment, the third switching unit 205 checks whether the coding flag is 1 or not to decide whether coding is performed or not (step S716). When the coding flag is 1 (coding is performed) (step S716: Yes), the third switching unit 205 switches the output terminal to connect the output terminal to the coding process unit 210, and a coding process is performed in the optimum coding mode determined by the coding mode control unit 207 (step S717). In this manner, any one of the first frame coding unit 131, the second frame coding unit 132, the first field coding unit 133, and the second field coding unit 134 performs a coding process.

On the other hand, in step S716, when the coding flag is set at 0, the third switching unit 205 switches the output terminal to connect the output terminal to an external circuit to and ends the process. In this manner, the second coding cost of the optimum coding mode is output to any one of the first frame tentative coding unit 111, the second frame tentative coding unit 112, the first field tentative coding unit 113, and the second field tentative coding unit 114.

Returning to step S701, when the coding flag is set at 1 (step S701: No), the processes in steps S702 to S715 to calculate the second coding cost are not performed. In the first frame coding unit 131, the second frame coding unit 132, the first field coding unit 133, and the second field coding unit 134, since the coding flags to perform coding are set at 1, No is determined in step S701.

In the moving picture coding apparatus according to the second embodiment, when an interlace-type moving picture is coded, with respect to a plurality of selectable coding modes, coding modes having small first coding costs which are calculated from prediction error signals of input image signals are selected as coding modes serving as candidates to reduce the number of modes. A tentative coding process is performed to the selected coding modes, and a coding mode having the minimum second coding cost calculated from a bitrate of coding data in the respective coding modes and a distortion is determined a coding mode in which a coding process is performed. For this reason, a coding process having high coding efficiency can be more appropriately and accurately performed to make it possible to select a coding mode. More specifically, a second coding cost is calculated from not only a bitrate but also a distortion, which is an image difference between a reference image obtained by decoding a prediction error signal calculated from a second input image to determine a coding mode having the minimum second coding cost, an influence by actual coding can also be considered to determine the coding code, and a more appropriate coding mode can be determined to make it possible to improve coding efficiency. For this reason, a preferable coding mode can be selected depending on the contents of macroblocks or the like to make it possible to realize appropriate coding having compression efficiency, and the number of coding modes in which tentative coding processes are actually performed is reduced. Therefore, an amount of calculation can be considerably reduced to make it possible to prevent load of the coding processes from increasing.

In the moving picture coding apparatus 100 according to the second embodiment, coding modes 2 each having a small first coding cost are selected as candidates from all the coding modes for an image of input macroblocks. However, the moving picture coding apparatus 100 according to the third embodiment, coding modes are excluded for an image of input macroblocks, and coding modes serving as candidates are selected from the limited coding modes.

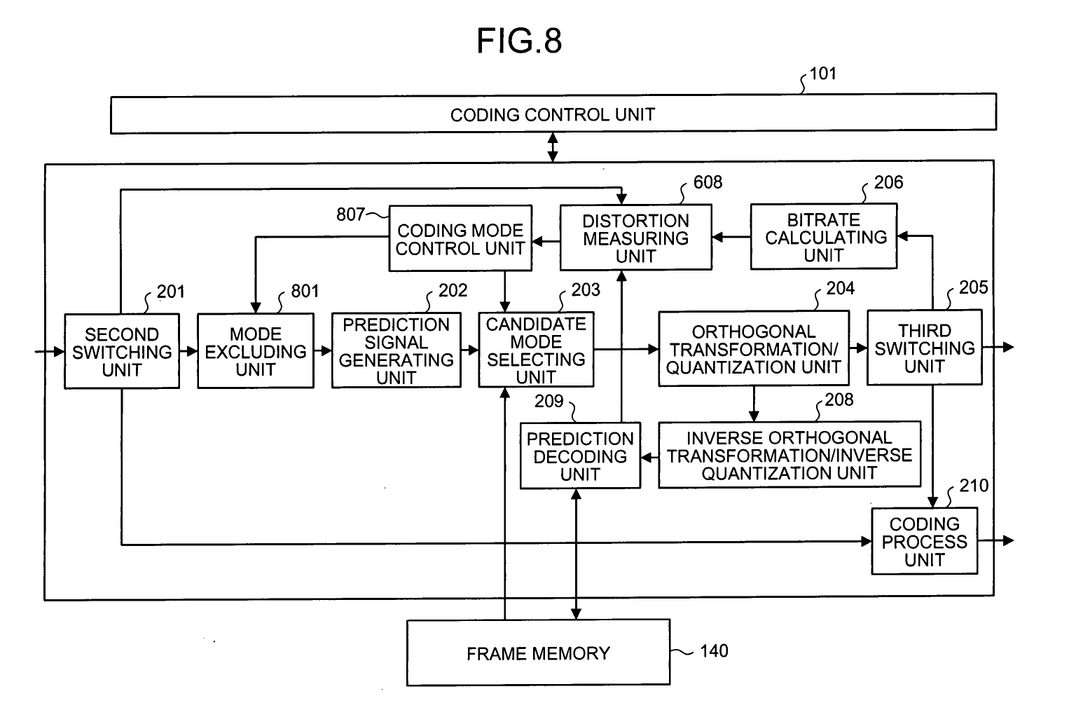

The functional configuration of the moving picture coding apparatus 100 according to the embodiment is the same as that of the moving picture coding apparatus according to the first embodiment shown in FIG. 1. FIG. 8 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 8, mainly includes a second switching unit 201, a mode excluding unit 801, a prediction signal generating unit 202, a candidate mode selecting unit 203, a orthogonal transformation/quantization unit 204, a third switching unit 205, a bitrate calculating unit 206, a distortion measuring unit 608, a coding mode control unit 807, an inverse orthogonal transformation/inverse quantization unit 208, a prediction decoding unit 209, and a coding process unit 210.

In this case, the functions and configurations of the prediction signal generating unit 202, the candidate mode selecting unit 203, the orthogonal transformation/quantization unit 204, the third switching unit 205, the bitrate calculating unit 206, the inverse orthogonal transformation/inverse quantization unit 208, the prediction decoding unit 209, and the coding process unit 210 are the same as those in the first embodiment. The function and configuration of the distortion measuring unit 608 are the same as those in the second embodiment. Coding modes used in the moving picture coding apparatus 100 according to the third embodiment are the same as those in the first embodiment.

The mode excluding unit 801 excludes coding modes in which calculation is actually performed in all coding modes which can be selected in tentative coding. The coding modes to be excluded are set in advance in mode excluding information.

As the mode excluding information, for example, when an image size of an input image is an SD size or larger, coding modes are limited to modes of inter-frame prediction coding using 4×4 pixel blocks and the like. When such mode excluding information is used, the modes of inter-frame prediction coding using the 4×4 pixel blocks are not used, modes of inter-frame prediction coding using 16×16 pixel blocks or the like, i.e., modes except for the modes of the inter-frame prediction coding using the 4×4 pixel blocks are used. The mode excluding information is held in a coding control unit 101 in tentative coding.

In each of the first frame tentative coding unit 111, the second frame tentative coding unit 112, the first field tentative coding unit 113, the second field tentative coding unit 114 (hereinafter referred to as a “tentative coding unit”), the second switching unit 201 is designed to output image signals of macroblocks to be input to the mode excluding unit 801. In each of the first frame coding unit 131, the second frame coding unit 132, the first field coding unit 133, and the second field coding unit 134 (hereinafter referred to as a “tentative coding unit”), the second switching unit 201 is designed to output image signals of macroblocks to be input and coding information such as an orthogonal transformation coefficient and a prediction error signal calculated by the first frame tentative coding unit 111, the second frame tentative coding unit 112, the first field tentative coding unit 113, and the second field tentative coding unit 114 to the coding process unit 210. In this manner, the coding process unit 210 is designed to perform a coding process in a coding mode determined by a tentative coding mode to the image signals of the macroblocks to be input.

As in the second embodiment, when an output terminal of the third switching unit 205 is connected to the bitrate calculating unit 206, the coding mode control unit 807 sequentially sets executable coding modes in the candidate mode selecting unit 203 to calculate a second coding cost, so that a coding mode in which a coding process is performed is determined. However, the embodiment is further designed such that the mode excluding information is set by the coding control unit 101 in the tentative coding process.

The coding mode control unit 807 performs control not to generate a prediction signal for coding modes set by the mode excluding information not to calculate a first coding cost and a second coding cost during a tentative coding process. More specifically, in the tentative coding unit (the first frame tentative coding unit 111, the second frame tentative coding unit 112, the first field tentative coding unit 113, or the second field tentative coding unit 114), an output terminal of the second switching unit 201 is connected to the prediction signal generating unit 202 through the mode excluding unit 801. However, the prediction signal generating unit 202 performs a prediction signal generating process to only moves which are not excluded by the mode excluding unit 801, and the coding mode control unit 807 controls modes to execute a process of calculating a second coding cost.

On the other hand, in the coding unit (the first frame coding unit 131, the second frame coding unit 132, the first field coding unit 133, or the second field coding unit 134), an output terminal of the second switching unit 201 is connected to the prediction signal generating unit 202 through the mode excluding unit 801 as in the tentative coding. In this case, with respect to the modes excluded in the tentative coding, the coding mode control unit 807 controls the modes such that the a prediction signal generating process is performed by the prediction signal generating unit 202 and processes (processes in the candidate mode selecting unit 203 o the orthogonal transformation/quantization unit 204→the bitrate calculating unit 206→the distortion measuring unit 608→the coding mode control unit 807) of calculating a first coding cost, a second coding cost, and the like are executed.

With respect to coding modes the second coding costs of which have been calculated by the tentative coding units, a prediction signal generating process and a tentative coding process are not performed because mode information and the second coding costs are held in the coding mode control unit 807.

In the coding processes by the coding units, all tentative coding processes, which can be selected by macroblocks are performed. A coding mode having the minimum second coding cost selected from the second coding costs held in the coding mode control unit 807, and a coding process is performed in the determined coding mode.

A prediction signal, which is not generated by the mode excluding unit 801 in the tentative coding process is generated after a coding structure is determined. For this reason, a coding process can be realized without deteriorating coding efficiency in the macroblocks.

The moving picture coding process in the moving picture coding apparatus 100 according to the embodiment arranged as described above will be described below. The same procedure (FIG. 4) as that of the first embodiment is performed with respect to all the processes of moving picture coding.

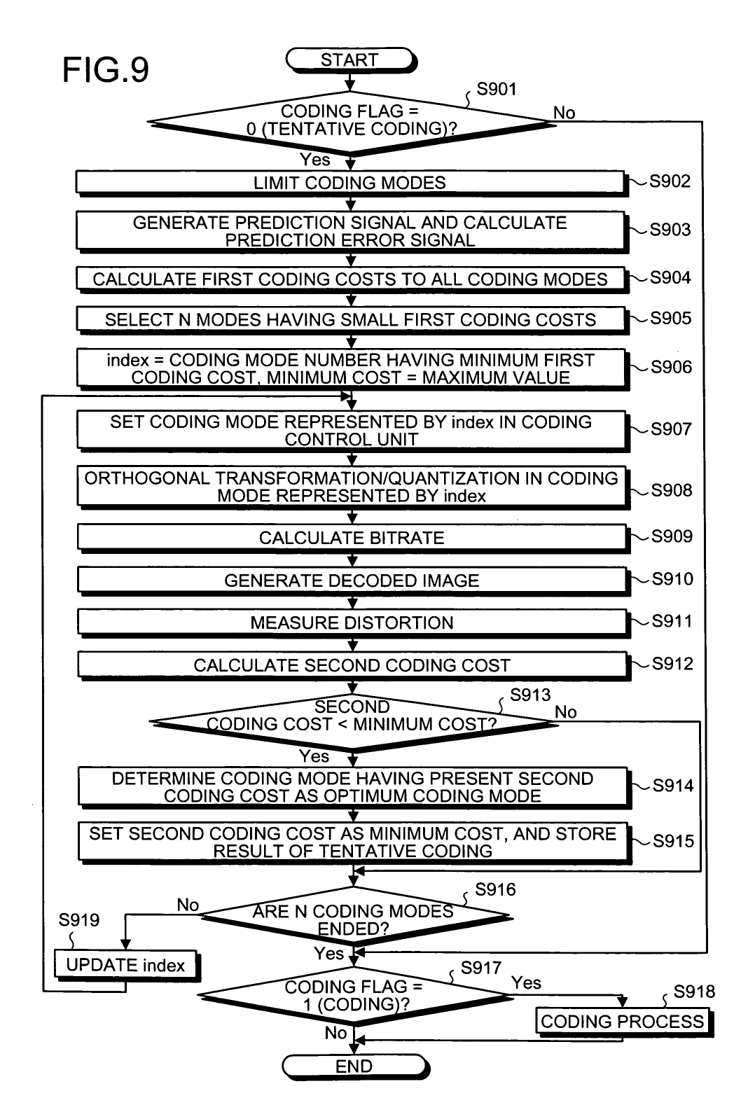

Tentative coding processes in steps S403, S404, S406, and S407 and coding processes in steps S410, S411, S412, and S413 in all the processes (FIG. 4) of moving picture coding will be described in detail. FIG. 9 is a flow chart showing a procedure of the tentative coding processes and the coding processes.

When moving picture signals are input for respective macroblocks, coding of the input images is started for respective macroblocks. The second switching unit 201 refers to a coding flag set by the coding control unit 101 to check whether the coding flag is set at 0 or not to decide whether tentative coding is performed or not (step S901).

Processes related to the first frame tentative coding unit 111, the second frame tentative coding unit 112, the first field tentative coding unit 113, and the second field tentative coding unit 114 will be described below. When image signals are input to the first frame tentative coding unit 111, the second frame tentative coding unit 112, the first field tentative coding unit 113, and the second field tentative coding unit 114, a coding flag is set at 0 to perform tentative coding (step S901: Yes). The second switching unit 201 switches the output terminal to the mode excluding unit 801 and outputs image signals of the input macroblocks to the mode excluding unit 801.

The coding modes are excluded by the mode excluding unit 801 according to mode excluding information set in the coding mode control unit 807 (step S902). For example, as described above, the mode excluding information includes modes or the like of inter-frame prediction coding using 4×4 pixel blocks. When such mode excluding information is used, coding modes to be processed are limited to coding modes except for the coding modes of the inter-frame prediction coding using 4×4 pixel blocks, e.g., coding modes or the like of inter-frame prediction coding using 16×16 pixel blocks.

A prediction signal and a prediction error signal are generated by the prediction signal generating unit 202. However, the processes (steps S903 to S918 and S919) subsequent to the generation of the prediction signal and the prediction error signal are performed in the same manner as that of the processes (step S72 to S718) in the moving picture coding apparatus 100 according to the first embodiment. For this reason, in the candidate mode selecting unit 203, coding modes serving as candidates are selected from the coding modes limited by the mode excluding unit 801, so that a coding mode having the minimum second coding cost is determined by the coding mode control unit 807.

In the moving picture coding apparatus 100 according to the third embodiment, coding modes are limited in advance for the images of input macroblocks, coding modes serving as candidates are selected from the limited coding modes, and a coding mode is determined in the coding modes. For this reason, coding having high coding efficiency can be more appropriately and accurately can be performed to make it possible to select a coding mode. For this reason, an appropriate coding mode can be selected depending on the contents of the macroblocks or the like, and appropriate coding having high compression efficiency can be realized. Since the number of coding modes in which tentative coding processes are actually performed is reduced, an amount of calculation can be considerably reduced to make it possible to prevent load of the coding processes from increasing.

In the moving picture coding apparatus 100, the second coding cost is calculated from a bitrate and a distortion. However, as in the moving picture coding apparatus according to the first embodiment, the bitrate itself may be used as the second coding cost.

In each of the moving picture coding apparatuses 100 according to the first to third embodiments, the first coding costs are calculated by the candidate mode selecting unit 203, and coding modes serving as candidates are selected from the coding modes in ascending order of the first coding costs. However, in the moving picture coding apparatus 100 according to the fourth embodiment, coding modes to be processed are limited based on image types of slices of image signals of input macroblocks.

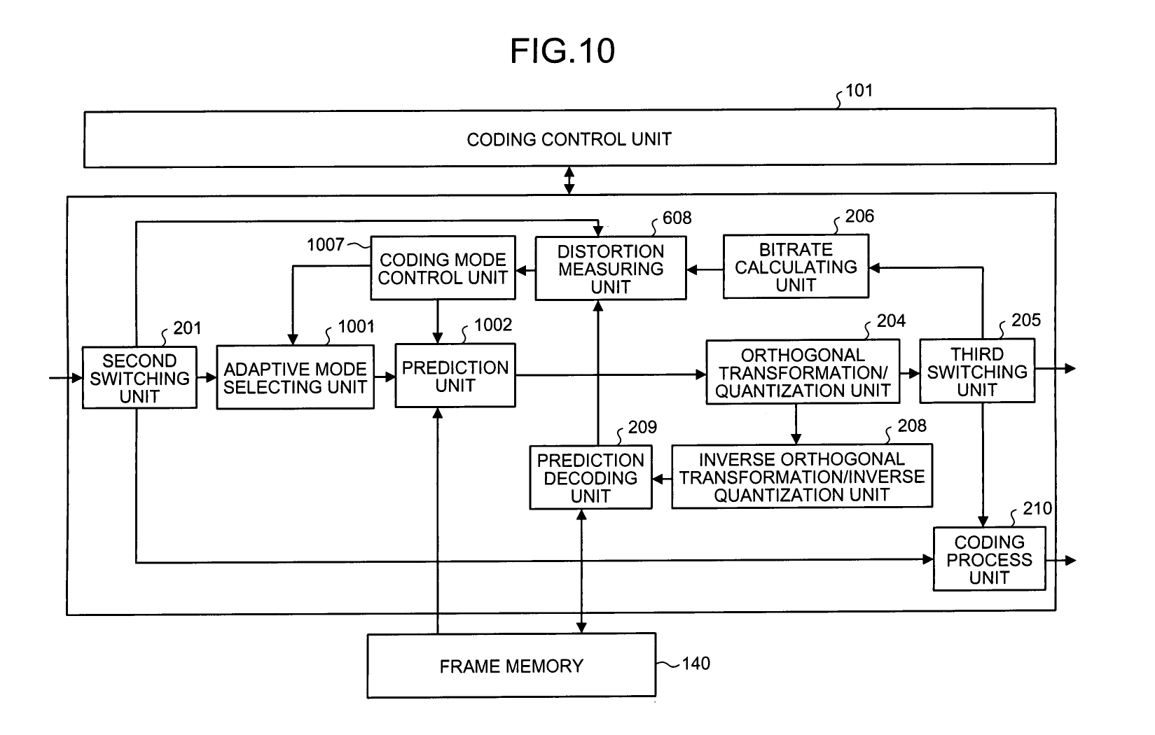

The functional configuration of the moving picture coding apparatus 100 according to the embodiment is the same as that of the moving picture coding apparatus according to the first embodiment shown in FIG. 1. FIG. 10 is a block diagram showing the functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 10, includes a second switching unit 201, an adaptive mode selecting unit 1001, a prediction unit 1002, an orthogonal transformation/quantization unit 204, a third switching unit 205, a bitrate calculating unit 206, a distortion measuring unit 608, a coding mode control unit 1007, an inverse orthogonal transformation/inverse quantization unit 208, a prediction decoding unit 209, and a coding process unit 210.

In this case, the functions and configurations of the second switching unit 201, the orthogonal transformation/quantization unit 204, the third switching unit 205, the bitrate calculating unit 206, the inverse orthogonal transformation/inverse quantization unit 208, the prediction decoding unit 209, and the coding process unit 210 are the same as those in the first embodiment. The function and configuration of the distortion measuring unit 608 is the same as those in the second embodiment. Coding modes used in the moving picture coding apparatus 100 according to the embodiment are the same as those in the first embodiment.

The moving picture coding apparatus 100 is different from the moving picture coding apparatus according to the first to third embodiment in that the adaptive mode selecting unit 1001 and the prediction unit 1002 are arranged in place of the prediction signal generating unit and the candidate mode selecting unit.

The adaptive mode selecting unit 1001 is to select a coding mode depending on types of images of input macroblocks. In this case, the types of the images include an I-picture (intra-frame coding image), a P-picture (inter-frame prediction coding image, and a B-picture (bidirectional prediction coding image). In the embodiment, the types of the images are decided for respective slices, and a coding mode having high coding efficiency is selected to each type.

For example, when an input image signal is an I-slice, the adaptive mode selecting unit 1001 selects coding modes which use intra-frame coding as a prediction method and which have block sizes and prediction modes having high coding efficiency for the I-slice from the coding modes shown in FIG. 3. For example, a coding mode having a block size of 16×16 and a DC prediction mode as a prediction mode is selected.

When the input image signal is a P-slice, the adaptive mode selecting unit 1001 selects coding modes which use inter-frame coding as a prediction method and which have block sizes and prediction modes having high coding efficiency for the P-slice. For example, a coding mode having a block size of 16×16 and a L0 prediction mode as a prediction mode is selected.

Furthermore, when the input image signal is a B-slice, the adaptive mode selecting unit 1001 selects coding modes which use inter-frame coding as a prediction method and which have block sizes and prediction modes having high coding efficiency for the B-slice.

When load of a coding process is considered, skip is selected in the prediction method of inter-frame prediction coding to make it possible to perform a prediction process at a high speed. However, coding performance is deteriorated. The selection of these prediction modes is performed in consideration of a processing rate and coding performance. In the embodiment, coding modes to be specified are predetermined for respective image types of slices in consideration of sizes and applications of macroblocks.

More specifically, the adaptive mode selecting unit 1001 specifies coding modes to be selected for respective image types of slices to reduce the number of tentative coding processes (process loop of the prediction unit 1002→the orthogonal transformation/quantization unit 204→the bitrate calculating unit 206→the distortion measuring unit 608) which are the subsequent high-load processes, thereby making it possible to perform a high-speed frame-field determination.

In the embodiment, as described above, coding modes to be selected for respective image types of slices are selected. However, when the prediction method of the intra-frame coding is compared with the prediction method of the inter-frame coding, a searching process of a motion vector or the like is not performed. For this reason, a high-speed arithmetic operation can be performed. Therefore, the I-slice may-be designed to select a coding mode, which targets all prediction modes corresponding to the sizes of input macroblocks from coding modes, which uses intra-frame coding as a prediction method.

The prediction unit 1002 generates prediction signals for respective coding modes sequentially set by the coding mode control unit 1007 by using a reference image temporarily stored in the frame memory 140 and coding process methods determined by the coding modes, and generates prediction error signals which are pixel differences between the image signals of the input macroblocks and the generated prediction signals. When the set coding modes are modes related to inter-frame prediction coding, the prediction signal generating unit 202 also performs a motion vector detecting process to perform motion compensation.

The prediction unit 1002 may generate prediction signals for all the respective coding modes corresponding to macroblocks to be processed or may generate prediction signals for only some coding modes of the coding modes corresponding to the macroblocks to be processed when an output terminal of the third switching unit 205 is connected to the bitrate calculating unit 206 (in tentative coding process), the coding modes selected by the adaptive mode selecting unit 1001 are sequentially set in the prediction unit 1002 to calculate coding costs, and a coding mode in which a coding process is executed is determined by the coding mode calculating unit 1007. Like the second coding cost according to the second embodiment, the coding cost is obtained by adding the bitrate calculated by the bitrate calculating unit 206 and a distortion measured by the distortion measuring unit 608 according to Equation (2), and is a value serving as a reference of an amount of coding process.

In each of the first frame tentative coding unit 111, the second frame tentative coding unit 112, the first field tentative coding unit 113, and the second field tentative coding unit 114 (hereinafter referred to as a “tentative coding unit”), the second switching unit 201 is designed to output image signals of macroblocks to be input to the adaptive mode selecting unit 1001. In each of the first frame coding unit 131, the second frame coding unit 132, the first field coding unit 133, and the second field coding unit 134 (hereinafter referred to as a “coding unit”), the second switching unit 201 is designed to output the coding information such as orthogonal transformation coefficients and prediction error signals calculated to a coding process unit 210 by the first frame tentative coding unit 111, the second frame tentative coding unit 112, the first field tentative coding unit 113, and the second field tentative coding unit 114. In this manner, the coding process unit 210 performs a coding process in a coding mode determined by the tentative coding unit to the image signals of the macroblocks to be input.

Moving picture coding processes in the moving picture coding apparatus 100 according to the embodiment arranged as described above will be described below. The same procedure (FIG. 4) as that of the first embodiment is performed with respect to all the processes of moving picture coding.

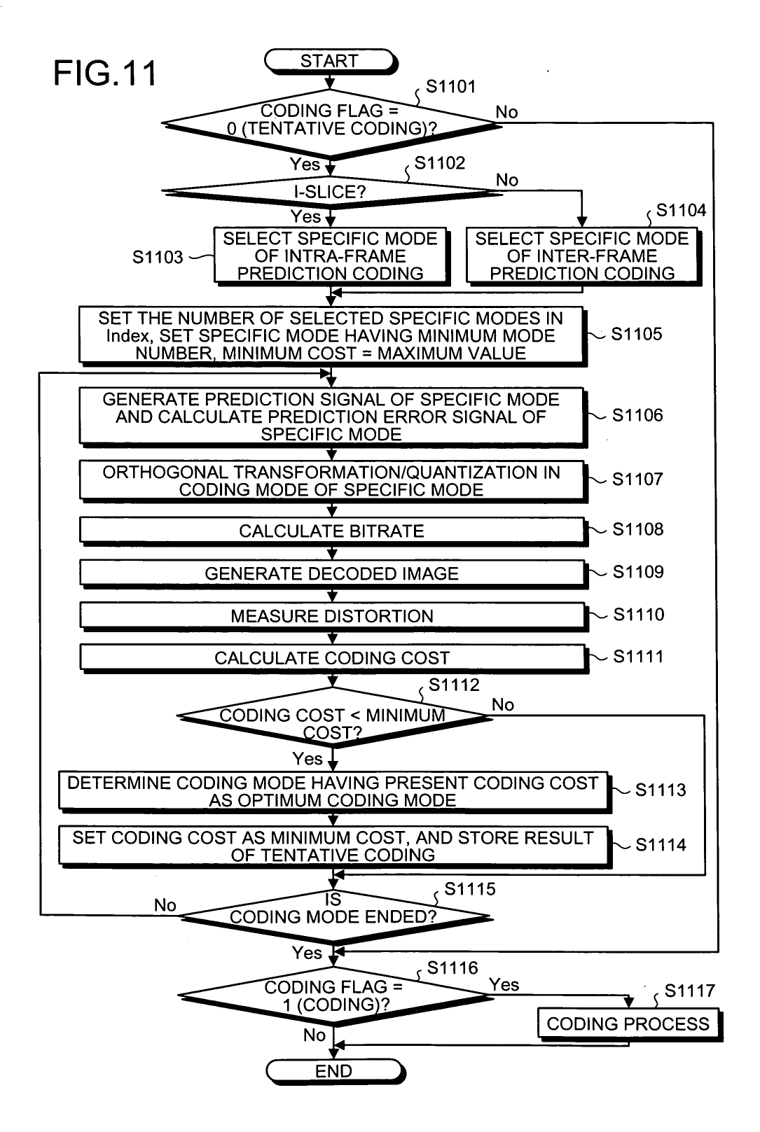

Tentative coding processes in steps S403, S404, S406, and S407 in all the processes of moving picture coding (FIG. 4) and coding processes in steps S410, S411, S412, and S413 will be described below. FIG. 11 is a flow chart showing procedures of the tentative coding processes and the coding processes.

When the moving picture signals are input for respective macroblocks, coding of the input images is started for respective macroblocks. The second switching unit 201 decides whether tentative coding is performed or not by checking whether the value of the coding flag set by the coding control unit 101 is 0 or not (step S1101).

In this case, processes related to the first frame tentative coding unit 111, the second frame tentative coding unit 112, the first field tentative coding unit 113, and the second field tentative coding unit 114 will be described here. When image signals are input to the first frame tentative coding unit 111, the second frame tentative coding unit 112, the first field tentative coding unit 113, and the second field tentative coding unit 114, a coding flag is set at 0 to perform tentative coding (step S1101: Yes). For this reason, the second switching unit 201 switches an output terminal to the adaptive mode selecting unit 1001 to output the image signals of the input macroblocks to the adaptive mode selecting unit 1001.

The adaptive mode selecting unit 1001 checks an image type of the image signals of the input macroblocks to decide whether the image type is an I-slice or not (step S1102). When the image type is the I-slice, the adaptive mode selecting unit 1001 selects coding modes which use intra-frame coding as a prediction method and which have block sizes and prediction modes having high coding efficiency for the I-slice (for example, the block size is 16×16, and the prediction mode is a DC prediction mode) as specific modes from the coding modes shown in FIG. 3 (step S1103).

On the other hand, in step S1102, when the image type of the image signals of the input macroblocks is a slice except for the I-slice (P-slice or B-slice), the adaptive mode selecting unit 1001 selects coding modes which use inter-frame prediction coding as a prediction method and which have block sizes and prediction modes having high coding efficiency for the P-slice or the B-slice (for example, the block size is 16×16, and the prediction mode is a P0 prediction mode) as specific modes from the coding modes shown in FIG. 3 (step S1104).

The number of coding modes selected as the specific modes in step S1103 or S1104 is set in a variable index, a coding mode having the minimum mode number in the specific coding modes is set as a specific mode to be processed, and a maximum value predetermined as the minimum cost is set (step S1105).

A prediction signal and a prediction error signal are generated by the prediction unit 1002 according to a coding method of the specific mode to be processed (step S1106).

When an output of the third switching unit 205 is connected to the bitrate calculating unit 206, the coding mode control unit 1007 sets the coding mode having a mode number represented by a value of an index in the coding control unit 101. In this manner, an orthogonal transformation process and a quantization process corresponding to the coding mode, which is the specific mode to be processed are performed by the orthogonal transformation/quantization unit 204 (step S1107). More specifically, the orthogonal transformation/quantization unit 204 orthogonally transforms the prediction error signal and quantizes an orthogonal transformation coefficient.

The bitrate calculating unit 206 calculates a bitrate generated when entropy coding based on Huffman coding or arithmetic coding is performed to the quantized orthogonal transformation coefficient and the information of the motion vector (step S1108). However, entropy coding data is not output.

When the orthogonal transformation/quantization unit 204 orthogonally transforms the prediction error signal and quantizes the orthogonal transformation coefficient in step S1107, and when the bitrate calculating unit 206 performs the entropy coding based on the Huffman coding or the arithmetic coding to the quantized orthogonal transformation coefficient and the information of the motion vector in step S1108, in execution of a process of calculating a bitrate, the quantized orthogonal transformation coefficient of the prediction error signal is input to the inverse orthogonal transformation/inverse quantization unit 208 and subjected to inverse quantization/inverse orthogonal transformation to reproduce a prediction error signal. The prediction decoding unit 209 generates a local decode image serving as a decoded image. The local device image is temporarily stored in the frame memory 140 as a reference image (step S1109).

The distortion measuring unit 608 measures a distortion which is an image difference between the reference image in the frame memory 140 and an input image to be coded (original image obtained before coding) (step S1110).

The coding mode control unit 1007 calculates a coding cost from the bitrate calculated in step S1108 and the distortion measured in step S1109 according to Equation (2) (step S1111).

The coding mode control unit 1007 decides whether the calculated coding cost is smaller than the minimum cost (step S1112). When the coding cost is smaller than the minimum cost (step S1112: Yes), the coding mode control unit 1007 determines a coding mode which is a specific mode corresponding to a present coding cost as an optimum coding mode (step S1113). The minimum cost is updated with the present coding cost. A result of tentative coding, i.e., coding data generated by a coding process in the specific mode is held in the frame memory 140 (step S1114).

The coding mode control unit 1007 decides whether the processes to all the coding modes selected as the specific modes are ended or not (step S1115). When the processes to the coding modes, which are all the specific modes, are not ended (step S1115: No), the processes in steps S1106 to S1114 are repeatedly executed to the next coding modes selected as the specific modes. In this manner, a coding mode having the minimum coding cost is determined.

On the other hand, when the processes are ended to all the coding modes selected as specific modes in step S1115 (step S1115: Yes), the third switching unit 205-checks whether the coding flag is set at 1 or not to decide whether coding is performed or not (step S1116). When the coding flag is set at 1 (coding is performed) (step S1116: Yes), the third switching unit 205 switches an output terminal to connect the output terminal to the coding process unit 210 and performs a coding process in the optimum coding mode determined by the coding mode control unit 1007 (step S1117). In this manner, the coding process is performed by any one of the first frame coding unit 131, the second frame coding unit 132, the first field coding unit 133, and the second field coding unit 134.

On the other hand, when the coding flag is set at 0 in step S1116, the third switching unit 205 switches the output terminal to connect the output terminal to an external circuit and ends the process. In this manner, an optimum code or a mode coding cost is output to any one of the first frame tentative coding unit 111, the second frame tentative coding unit 112, the first field tentative coding unit 113, and the second field tentative coding unit 114.

Returning to step S1101, when the coding flag is set at 1 (step S1101: No), the process of calculating a coding cost in steps S1102 to S1115 is not performed. In each of the first frame coding unit 131, the second frame coding unit 132, the first field coding unit 133, and the second field coding unit 134, the coding flag is set at 1 to perform coding. For this reason, No is determined in step S1101.

In the moving picture coding apparatus according to the embodiment described above, when an interlace-type moving picture is to be coded, coding modes having high coding efficiency are selected depending on image types of input macroblocks from a plurality of selectable coding modes to reduce the number of modes, and a tentative coding process is performed to the selected coding modes, so that a coding mode having the minimum coding cost calculated from a bitrate of coding data in the coding modes is determined as a coding mode in which a coding process is performed. For this reason, coding having high coding efficiency can be appropriately and accurately performed to make it possible to select a coding mode. Therefore, a preferable coding mode can be selected depending on the contents of macroblocks or the like, preferable coding having high compression efficiency can be realized, and the number of coding modes in which tentative coding processes are actually performed is reduced depending on image types. Consequently, the amount of calculation can be considerably reduced, and load of the coding processes can be prevented from increasing.

Furthermore, since coding data calculated in tentative coding is held as a specific mode, the specific mode need not be virtually coded in the coding process. For this reason, with respect to a specific mode corresponding to a coding structure selected by a field/frame decision, calculation may not be performed in the coding process performed by the coding apparatus, and load of the coding processes can be further reduced.

In the moving picture coding apparatus 100 according to the fourth embodiment, coding modes to be processes are limited based on the image types of slices of image signals of input macroblocks. However, the moving picture coding apparatus according to the fifth embodiment further limits coding modes to be processed depending on block sizes (block sizes).

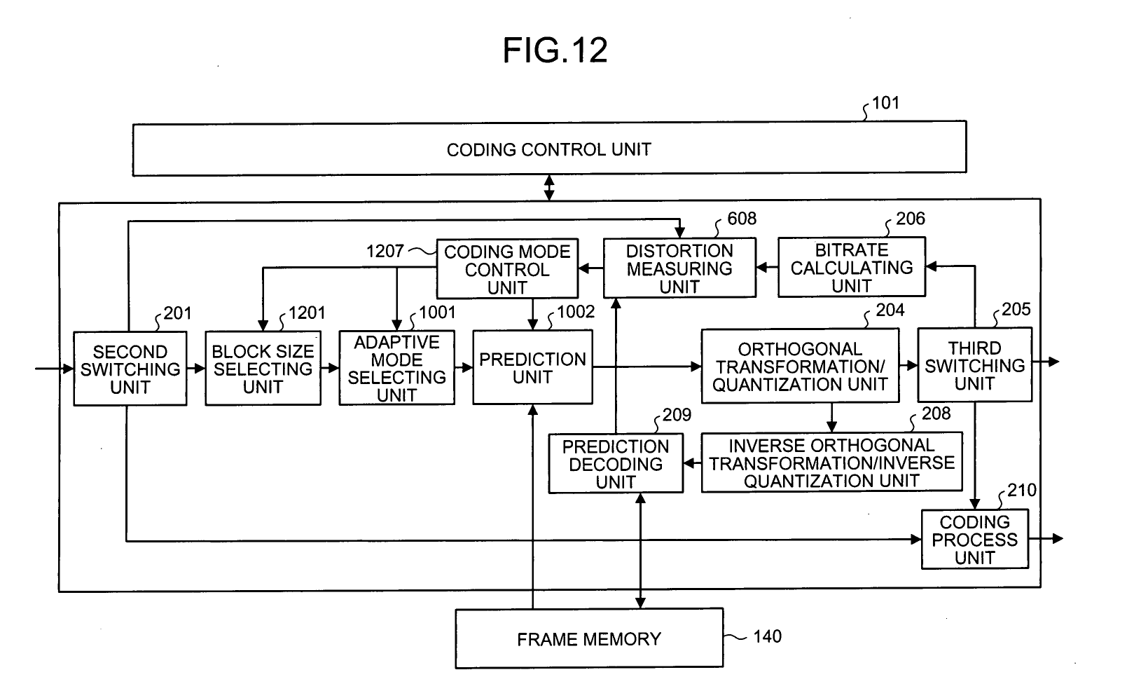

The functional configuration of the moving picture coding apparatus 100 according to the embodiment is the same as that of the moving picture coding apparatus according to the embodiment shown in FIG. 1. FIG. 12 is a block diagram showing the functional configurations of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134.

Each of the first frame tentative coding unit 111, the second frame tentative coding unit 112, the first field tentative coding unit 113, the second field tentative coding unit 114, the first frame coding unit 131, the second-frame coding unit 132, the first field coding unit 133, and the second field coding unit 134, as shown in FIG. 12, mainly includes a second switching unit 201, a block size selecting unit 1201, an adaptive mode selecting unit 1001, a prediction unit 1002, an orthogonal transformation/quantization unit 204, a third switching unit 205, a bitrate calculating unit 206, a distortion measuring unit 608, a coding mode control unit 1207, an inverse orthogonal transformation/inverse quantization unit 208, a prediction decoding unit 209, and a coding process unit 210.

In this case, the functions and configurations of the second switching unit 201, the orthogonal transformation/quantization unit 204, the third switching unit 205, the adaptive mode selecting unit 1001, the bitrate calculating unit 206, the distortion measuring unit 608, the inverse orthogonal transformation/inverse quantization unit 208, the prediction decoding unit 209, and the coding process unit 210 are the same as those in the fourth embodiment. Coding modes used in the moving picture coding apparatus 100 according to the embodiment are the same as those in the first embodiment.

The moving picture coding apparatus 100 according to the embodiment is different from the moving picture coding apparatus according to the fourth embodiment in that the block size selecting unit 1201 is arranged.

In a tentative coding process, the block size selecting unit 1201 selects a coding mode corresponding to a block size in which calculation is performed based on image types of input image signals and block selection information from all selective block sizes.

The block selection information is set by the coding control unit 101, and determines a coding mode obtained by combining a prediction method and a block size (block size), which can be selected in the prediction method. For example, in a main profile of the moving picture coding apparatus 100 according to the embodiment in conformity to international standards, e.g., H. 264, block sizes which can be used in an intra-frame coding prediction method include a 16×16 pixel block and a 4×4 pixel block. Four types of prediction modes can be selected in the 16×16 pixel block, and nine types of prediction modes can be selected in 4×4 pixel block. Block sizes which can be used in an inter-frame prediction coding prediction method include a 16×16 pixel block, a 16×8 pixel block, an 8×16 pixel block, an 8×8 pixel block, an 8×4 pixel block, a 4×8 pixel block, a 4×4 pixel block, and the like. A block size and a prediction mode of a reference image are determined. Therefore, as block selection information, any one or both of the 16×16 pixel block and the 4×4 pixel block can be selected when the image type of the input image signal is an I-slice (intra-frame coding image). When the image type of the input image signal is a P-slice or a B-slice, any one of the 16×16 pixel block, a 16×8 pixel block, the 8×16 pixel block, the 8×8 pixel block, the 8×4 pixel block, the 4×8 pixel block, and the 4×4 pixel block, a combination thereof, or all of these blocks is determined to be selectable. The block selection information is designed to be received by the coding mode control unit 1207 from the coding control unit 101 and to be set in the block size selecting unit 1201.

The adaptive mode selecting unit 1001 selects coding modes having high coding efficiency as in the fourth embodiment from coding modes corresponding to the block sizes selected by the block size selecting unit 1201. In this manner, the block size selecting unit 1201 selects coding modes corresponding to the block size in advance, and the adaptive mode selecting unit 215 can select a selectable mode from the coding modes corresponding to the block size, so that a mode calculated by a mode decision can be selected in consideration of a process load. As a result, an amount of process can be considerably reduced.

In each of the first frame tentative coding unit 111, the second frame tentative coding unit 112, the first field tentative coding unit 113, and the second field tentative coding unit 114 (hereinafter referred to as “tentative coding units”), the second switching unit 201 is designed to output image signals of macroblocks to be input to the block size selecting unit 1201. In each of the first frame coding unit 131, the second frame coding unit 132, the first field coding unit 133, and the second field coding unit 134 (hereinafter referred to as “coding units”), the second switching unit 201 is designed to output the image signals of the macroblocks to be input, coding information such as orthogonal transformation coefficients and prediction error signals calculated by the first frame tentative coding unit 111, the second frame tentative coding unit 112, the first field tentative coding unit 113, and the second field tentative coding unit 114 to the coding process unit 210. In this manner, the coding process unit 210 performs a coding process in a coding mode determined by the tentative coding units to the image signals of the macroblocks to be input.

When an output terminal of the third switching unit 205 is connected to the bitrate calculating unit 206, the coding mode control unit 1207, as in the fourth embodiment, sequentially sets executable coding modes in the prediction unit 1002 and calculates coding costs to determine a coding mode executed as a coding process. However, in the fifth embodiment, block size information is set by the coding control unit 101 in a tentative coding process.

The coding mode control unit 1207 performs control such that a prediction signal is not generated for a coding mode corresponding to a block size, which is not selected by the block size selecting unit, and a coding cost is not calculated in a tentative coding process. More specifically, in each of the tentative coding units (the first frame tentative coding unit 111, the second frame tentative coding unit 112, the first field tentative coding unit 113, and the second field tentative coding unit 114), an output terminal of the second switching unit 201 is connected to the prediction unit 1002 through the block size selecting unit 1201. A prediction signal generating process is performed by the prediction unit 1002 to only the coding modes corresponding to the block sizes selected by the block size selecting unit 1201, and control is performed by the coding mode control unit 1207 to execute a process such as a process of calculating a coding cost.

On the other hand, in each of the coding units (the first frame coding unit 131, the second frame coding unit 132, the first field coding unit 133, and the second field coding unit 134), an output terminal of the second switching unit 201 is connected to the prediction unit 1002 through the block size selecting unit 1201 as in a tentative coding process. In this case, the prediction unit 1002 performs a prediction signal generating process with respect to a mode which is not selected by the block size selecting unit 1201 in the tentative coding process, and control is performed by the coding mode control unit 1207 to execute a process of calculating a coding cost or the like (the processes of the prediction unit 1002→the orthogonal transformation/quantization unit 204→the bitrate calculating unit 206→the distortion measuring unit 608→the coding mode control unit 1207).

A moving picture coding process in the moving picture coding apparatus 100 according to the embodiment arranged as described above will be described below. All the processes of the moving picture coding are performed in the same procedure (FIG. 4) as that in the first embodiment.

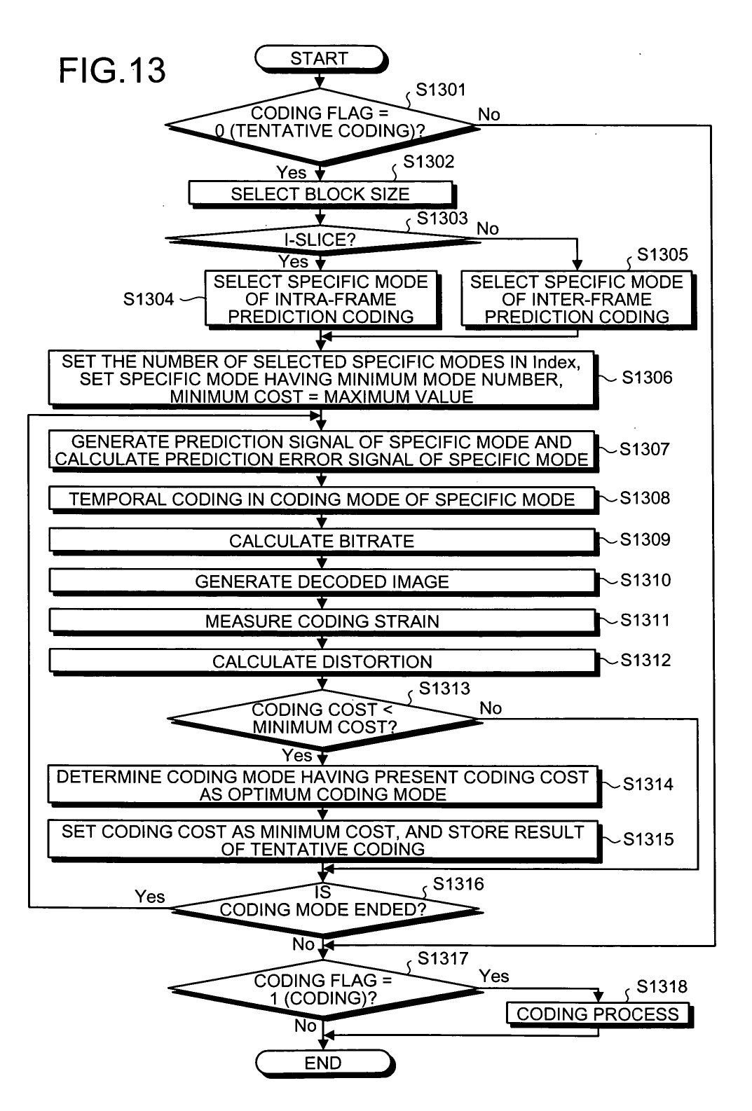

Tentative coding processes in steps S403, S404, S406, and S407 and coding processes in steps S410, S411, S412, and S413 in all the processes (FIG. 4) of the moving picture coding will be described below. FIG. 13 is a flow chart showing a procedure of the tentative coding processes and the coding processes.

When moving picture signals are input for respective macroblocks, the input images are coded for respective macroblocks. The second switching unit 201 refers to a coding flag set by the coding control unit 101 to check whether the coding flag is set at 0 or not to decide whether tentative coding is performed or not (step S1301).

In this case, processes related to the first frame tentative coding unit 111, the second frame tentative coding unit 112, the first field tentative coding unit 113, and the second field tentative coding unit 114 will be described below. When image signals are input to the first frame tentative coding unit 111, the second frame tentative coding unit 112, the first field tentative coding unit 113, and the second field tentative coding unit 114, since a coding flag is set at 0 to perform tentative coding (step S1301: Yes),the second switching unit 201 switches the output terminal to the block size selecting unit 1201 and outputs image signals of the input macroblocks to the block size selecting unit 1201.

The block size selecting unit 1201 refers to block selection information to select a block size (step S1302). More specifically, image types of input image signals are checked. When the image type is an I-slice, any one or both of a 16×16 pixel block and a 4×4 pixel block can be selected according to block selection information. When the image type of the input image signal is a P-slice or a B-slice, any one of the 16×16 pixel block, a 16×8 pixel block, an 8×16 pixel block, an 8×8 pixel block, an 8×4 pixel block, a 4×8 pixel block, and the 4×4 pixel block, a combination thereof, or all of these blocks is selected according to the block selection information.

The adaptive mode selecting unit 1001 checks the image type of image signals of input macroblocks to decide whether the image type is the I-slice or not (step S1303). When the image type is the I-slice, the adaptive mode selecting unit 1001 selects, as a specific mode, coding modes which use intra-frame coding as a prediction method, which have block sizes selected in step S1302, and which have a predetermined prediction mode (for example, the prediction mode is a DC prediction mode) having high coding efficiency for the I-slice from the coding modes shown in FIG. 3 (step S1304).

On the other hand, in step S1303, when the image type of the image signals of the input macroblocks is a slice except for the I-slice (P-slice or B-slice), the adaptive mode selecting unit 1001 selects coding modes which use inter-frame prediction coding as a prediction method and which have block sizes selected in the coding modes shown in FIG. 3 and prediction modes having high coding efficiency for the P-slice or the B-slice (for example, the block size is 16×16, and the prediction mode is a P0 prediction mode) as specific modes from the coding modes shown in FIG. 3 (step S1305).

The subsequent processes are performed in the same manner as that of the processes in steps S1105 to S1117 in the fourth embodiment.

In this manner, in the moving picture coding apparatus according to the fifth embodiment, when an interlace-type moving picture is to be coded, a block size is selected depending on the image types of image signals input from a plurality of selectable coding modes, coding modes having the block sizes selected is adaptively selected from the coding modes depending on the image type of the slice of the image signal, a tentative coding process is performed to the selected coding modes, and a coding mode having the minimum coding cost calculated from a bitrate of the coded data in the coding modes is determined as a coding mode in which a coding process is performed. For this reason, coding having high coding efficiency can be appropriately and accurately performed to make it possible to select a coding mode. Therefore, preferable coding modes can be selected depending on the contents of macroblocks or the like, appropriate coding having high compression efficiency can be realized, and the number of coding modes in which tentative coding processes are actually performed is reduced depending on image types. Consequently, the amount of calculation can be considerably reduced, and load of the coding processes can be prevented from increasing.

In the moving picture coding apparatus 100 according to the fourth embodiment, coding modes to be processed are limited based on image types of slices of image signals of the input macroblocks. In a moving picture coding apparatus according to a sixth embodiment, when a coding mode related to inter-frame prediction coding is selected, motion searching accuracy is selected, and a coding mode is selected depending on the motion searching accuracy.

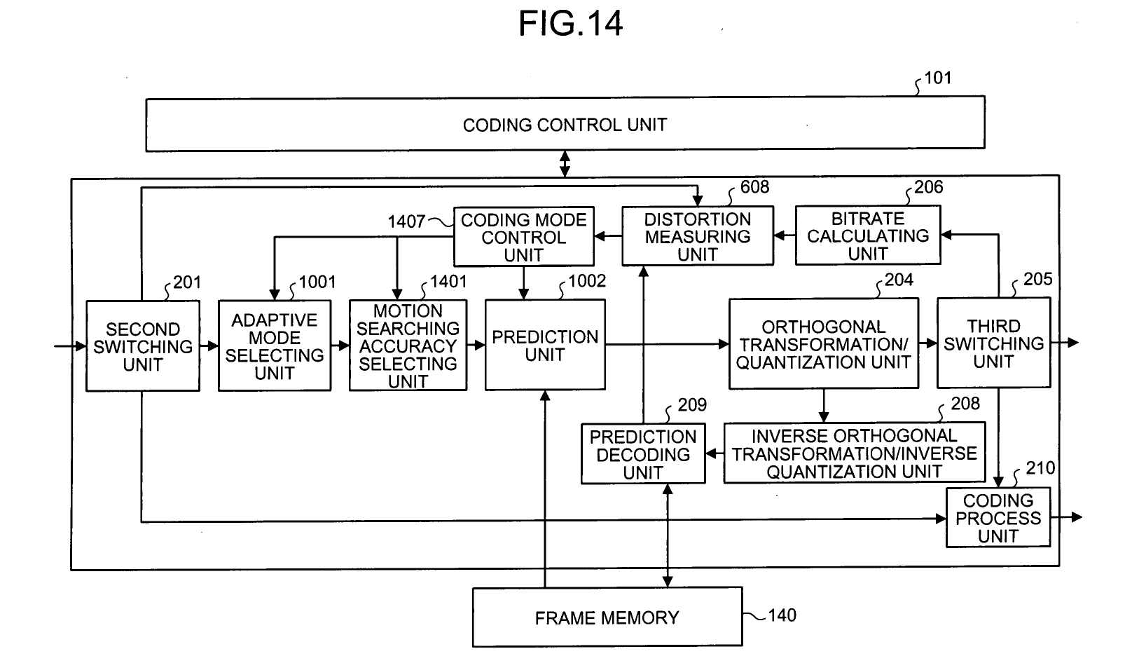

The functional configuration of the moving picture coding apparatus 100 according to the embodiment is the same as that of the moving picture coding apparatus according to the first embodiment shown in FIG. 1. FIG. 14 is a block diagram showing the functional configuration of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 14, mainly includes a second switching unit 201, a motion searching accuracy selecting unit 1401, an adaptive mode selecting unit 1001, a prediction unit 1002, an orthogonal transformation/quantization unit 204, a third switching unit 205, a bitrate calculating unit 206, a distortion measuring unit 608, a coding mode control unit 1407, an inverse orthogonal transformation/inverse quantization unit 208, a prediction decoding unit 209 and a coding process unit 210.

In this case, the functions and configurations of the second switching unit 20l, the orthogonal transformation/quantization unit 204, the third switching unit 205, the adaptive mode selecting unit 1001, the bitrate calculating unit 206, the distortion measuring unit 608, the inverse orthogonal transformation/inverse quantization unit 208, the prediction decoding unit 209, and the coding process unit 210 are the same as those in the fourth embodiment. The coding modes used in the moving picture coding apparatus 100 according to the embodiment are the same as those in the first embodiment.

The moving picture coding apparatus 100 is different from the moving picture coding apparatus according to the fourth embodiment in that the motion searching accuracy selecting unit 1401 is arranged.

When a coding mode selected by the adaptive mode selecting unit 1001 is a coding method of inter-frame prediction coding, the motion searching accuracy selecting unit 1401 receives motion searching accuracy information from the coding mode control unit 1407, selects a motion searching accuracy according to the motion searching accuracy information, and selects a coding mode having a prediction mode having the selected searching accuracy to control a motion searching process of the prediction unit 1002.

More specifically, the prediction unit 1002 performs not only the processes of intra-frame prediction coding and inter-frame prediction coding, but also a motion vector detection process. However, in the motion vector searching process, not only vector searching of an integer pixel position, but also vector searching of a fractional-number pixel position such as a ½ pixel position and a ¼ pixel position are performed. The vector searching process of the functional-number pixel position as described above is effective to improve coding efficiency. However, since the number of searching points to perform an image matching process increases, a processing load is excessive.

For this reason, when the coding method of the coding mode selected by the adaptive mode selecting unit 1001 is inter-frame prediction coding, a motion searching accuracy is selected, and a coding mode having a prediction mode of the selected motion searching accuracy is further selected. In the prediction unit 1002, motion vector searching is performed at the motion searching accuracy of the selected coding mode based on a reference image corresponding to each macroblock the motion searching accuracy selecting unit 1401. In this case, with respect to a motion searching accuracy, which is not selected by the motion searching accuracy selecting unit 1401, calculation such as a tentative coding process is not performed. For example, when the motion searching accuracy is obtained at only an integer pixel, in the prediction signal generating process performed by the prediction unit 1002, only a motion searching of integer accuracy may be performed. In this manner, the processing load can be considerably reduced.

The motion searching accuracy information associates pixel sizes and motion searching accuracies of an integer pixel position, a ½ pixel position, a ¼ pixel position, and the like. In the embodiment, the association is performed such that the motion searching accuracy is reduced as an image size increases. This is because a change in brightness in a macroblock tends to be moderate as the image size increases. That is, coding accuracy is not deteriorated even though the motion searching accuracy is relatively increases. In the embodiment, the motion searching accuracy is determined depending on the image size. However, the motion searching accuracy information may be constituted such that the motion searching accuracy is selected depending on other conditions regardless of the image size.

When an output terminal of the third switching unit 205 is connected to the bitrate calculating unit 206, as in the fourth embodiment, the coding mode control unit 1407 sequentially sets executable coding modes in the prediction unit 1002 and calculates coding costs to determine a coding mode executed as a coding process. In the embodiment, in a tentative coding process, motion searching accuracy information is designed to be set by the coding control unit 101 and given to the motion searching accuracy selecting unit 1401.

The coding mode control unit 1407 performs control not to generate a prediction signal for coding modes having a motion searching accuracy, which is not selected by the motion searching accuracy selecting unit 1401 and to not calculate a coding cost during a tentative coding process. More specifically, in each of the tentative coding units (the first frame tentative coding unit 111, the second frame tentative coding unit 112, the first field tentative coding unit 113, and the second field tentative coding unit 114), the output terminal of the second switching unit 201 is connected to the prediction unit 1002 through the adaptive mode selecting unit 1001 and the motion searching accuracy selecting unit 1401. However, the prediction unit 1002 performs a prediction signal generating process to not only a coding mode to the motion searching accuracy selected by the motion searching accuracy selecting unit 1401. The coding mode is controlled by the coding mode control unit 1207 to execute a coding cost calculating process or the like.

On the other hand, in each of the coding units (the first frame coding unit 131, the second frame coding unit 132, the first field coding unit 133, and the second field coding unit 134), the output terminal of the second switching unit 201 is connected to the prediction unit 1002 through the adaptive mode selecting unit 1001 and the motion searching accuracy selecting unit 1401 as in the tentative coding. In this case, with respect to a mode which is not selected by the motion searching accuracy selecting unit 1401 in the tentative coding, a prediction signal generating process is performed by the prediction unit 1002, and control is performed by the coding mode control unit 1207 to execute a process of calculating a coding cost or the like (the processes of the prediction unit 1002→the orthogonal transformation/quantization unit 204→the bitrate calculating unit 206→the distortion measuring unit 608→the coding mode control unit 1207).

A moving picture, coding process in the moving picture coding apparatus 100 according to the embodiment arranged as described above will be described below. The same procedure (FIG. 4) as that of the first embodiment is performed with respect to all the processes of moving picture coding.

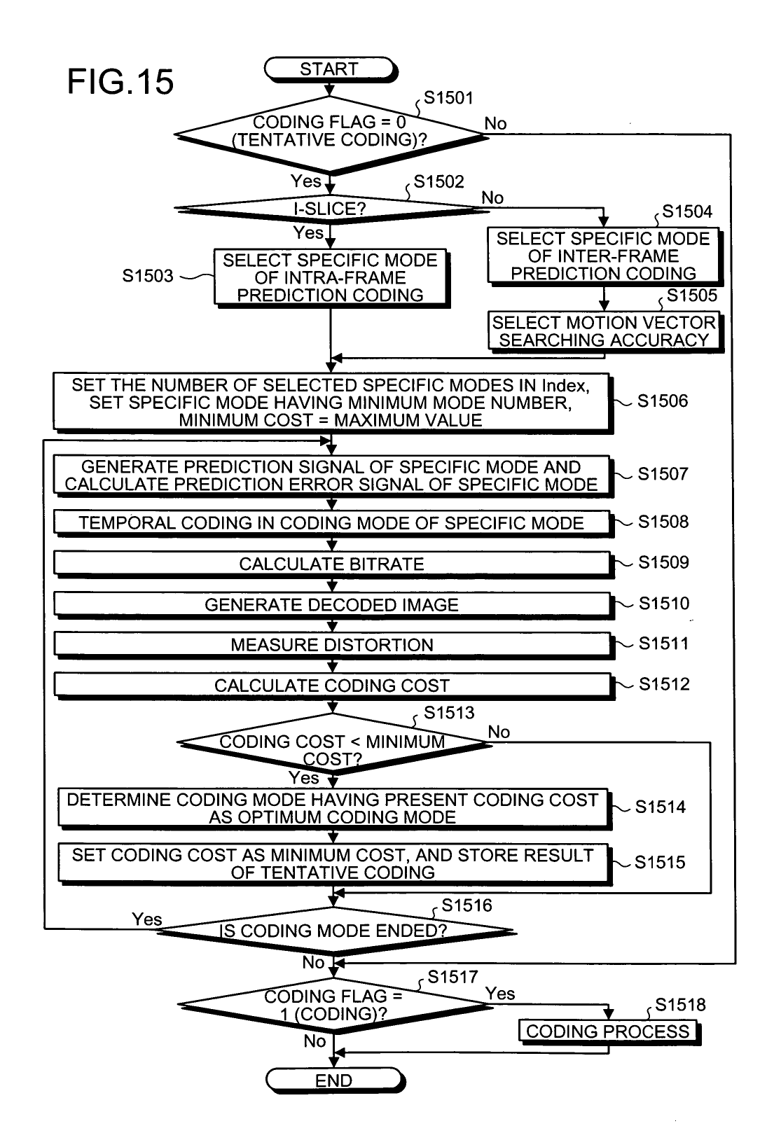

Tentative coding processes in steps S403, S404, S406, and S407 in all the processes of moving picture coding (FIG. 4) and coding processes in steps S410, S411, S412, and S413 will be described below. FIG. 15 is a flow chart showing procedures of the tentative coding processes and the coding processes.

When the moving picture signals are input for respective macroblocks, coding of the input images is started for respective macroblocks. The second switching unit 201 decides whether tentative coding is performed or not by checking whether the value of the coding flag set by the coding control unit 101 is 0 or not (step S1501).

Processes related to the first frame tentative coding unit 111, the second frame tentative coding unit 112, the first field tentative coding unit 113, and the second field tentative coding unit 114 will be described here. When image signals are input to the first frame tentative coding unit 111, the second frame tentative coding unit 112, the first field tentative coding unit 113, and the second field tentative coding unit 114, a coding flag is set at 0 to perform tentative coding (step S1501: Yes). For this reason, the second switching unit 201 switches an output terminal to the adaptive mode selecting unit 1001 to output the image signals of the input macroblocks to the adaptive mode selecting unit 1001.

The adaptive mode selecting unit 1001 checks an image type of the image signals of the input macroblocks to decide whether the image type is an I-slice or not (step S1502). When the image type is the I-slice, the adaptive mode selecting unit 1001 selects coding modes which use intra-frame coding as a prediction method and which have block sizes and prediction modes having high coding efficiency for the I-slice (for example, the block size is 16×16, and the prediction mode is a DC prediction mode) as specific modes from the coding modes shown in FIG. 3 (step S1503).

On the other hand, in step S1502, when: the image type of the image signals of the input macroblocks is a slice except for the I-slice (P-slice or B-slice), the adaptive mode selecting unit 1001 selects coding modes which use inter-frame prediction coding as a prediction method and which have block sizes and prediction modes having high coding efficiency for the P-slice or the B-slice (for example, the block size is 16×16, and the prediction mode is a P0 prediction mode) as specific modes from the coding modes shown in FIG. 3 (step S1504).

The motion searching accuracy selecting unit 1401 receives motion searching accuracy information from the coding mode control unit 1407, selects a motion searching accuracy depending on an image size, and selects a coding mode having the selected motion searching accuracy as a prediction mode as a specific mode from the coding modes selected in step S1504 (step S1505).

The number of coding modes selected as specific modes in step S1503 or 1504 is set in a variable index, a coding mode having the minimum mode number in the specific coding modes is set as a specific mode to be processed, and a maximum value predetermined as the minimum cost is set (step S1506). The subsequent processes are performed in the same manner as that of the processes in steps S1106 to S1117 in the fourth embodiment.

In this manner, in the moving picture coding apparatus according to the fifth embodiment, when an interlace-type moving picture is to be coded, input coding modes are selected from a plurality of selectable coding modes. When coding modes related to inter-frame prediction coding are selected, a motion searching accuracy is further selected to select coding modes depending on the selected motion searching accuracy, and a tentative coding process is performed to the selected coding modes. A coding mode having the minimum coding cost calculated from a bitrate of coded data in the coding modes is determined as a coding mode in which a coding process is performed. For this reason, coding having high coding efficiency can be appropriately and accurately performed to make it possible to select a coding mode. Therefore, preferable coding modes can be selected depending on the contents of macroblocks or the like, appropriate coding having high compression efficiency can be realized, and the number of coding modes in which tentative coding processes are actually performed is reduced depending on image types. Consequently, the amount of calculation can be considerably reduced, and load of the coding processes can be prevented from increasing.

The same block size selecting unit as that in the fifth embodiment may be arranged in the moving picture coding apparatus according to the sixth embodiment to select a block size to be coded based on an image type of an input image.

In the first to third embodiments, a first coding cost is calculated from all coding modes which can be executed to image signals of input macroblocks, coding modes serving as candidates are selected based on the first coding cost, and tentative coding is performed to calculate a second coding cost, so that a coding mode having the minimum second coding cost is determined. In a moving picture coding apparatus according to the seventh embodiment, coding modes serving as candidates are calculated, and a coding mode in which a coding process is performed is determined only the coding costs without performing tentative coding.

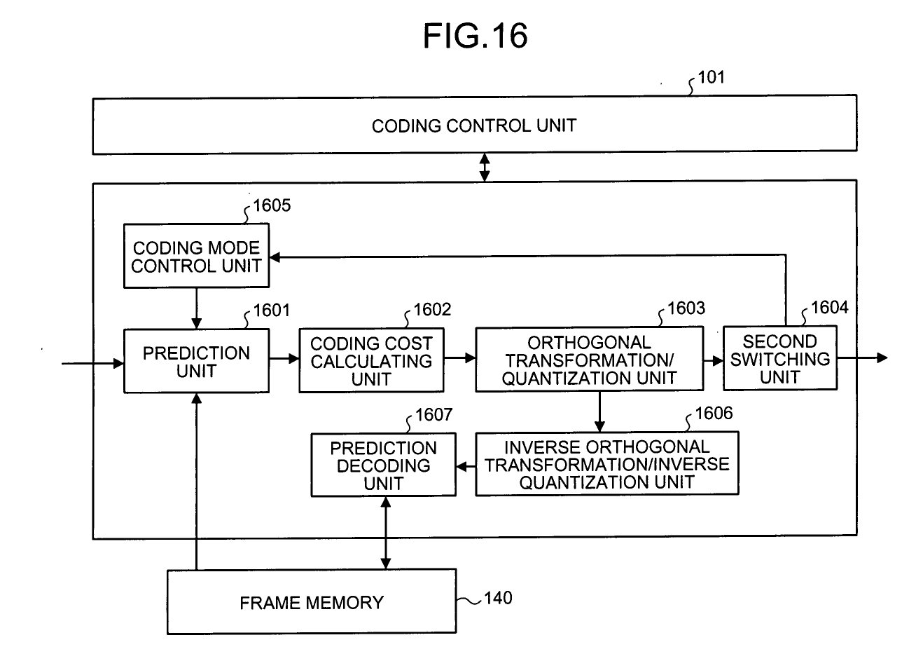

The functional configuration of the moving picture coding apparatus 100 according to the embodiment is the same as that of the moving picture coding apparatus according to the first embodiment. FIG. 16 is a block diagram showing functional configurations of a first frame tentative coding unit 111, a second frame tentative coding unit 112, a first field tentative coding unit 113, and a second field tentative coding unit 114.

Each of the first frame tentative coding unit 111, the second frame tentative coding unit 112, the first field tentative coding unit 113, and the second field tentative coding unit 114 (hereinafter referred to as “tentative coding units”), as shown in FIG. 16, mainly includes a prediction unit 1601, a coding cost calculating unit 1602, an orthogonal transformation/quantization unit 1603, a second switching unit 1604, a coding mode control unit 1605, an inverse orthogonal transformation/inverse quantization unit 1606, and a prediction decoding unit 1607.

For respective coding modes sequentially set by the coding mode control unit 1605, the prediction unit 1601 generates prediction signals by coding process methods determined by the coding modes while using a reference image temporarily stored in a frame memory 140 and generates prediction error signals which is pixel differences between image signals of input macroblocks and the generated prediction signals. When the set coding modes are related to inter-frame prediction coding, the prediction unit 1601 also performs a motion vector detecting process to perform motion compensation.

The prediction unit 1601 may generate prediction signals to all the coding modes corresponding to the macroblocks to be processed or may generate prediction signals with respect to only some coding modes.

The coding cost calculating unit 1602 calculates coding costs representing amounts of coding process in the coding modes from the prediction signals of the coding modes generated by the prediction unit 1002. In this case, the coding costs are calculated by Equation (3):
Cost=SAD+λ×OH (3)

Where SAD is an intra-macroblock pixel accumulation value of a prediction error signal, and λ is a constant. Reference symbol OH denotes a predetermined bitrate of mode information when a present coding modes is selected. The bitrate corresponds to a distance of a motion vector or the like.

In this manner, the coding cost can be calculated by only the prediction error signal. For this reason, the coding cost can be calculated at a speed considerably higher than that of a bitrate calculating process (to be described later. Therefore, a coding structure can be selected based on the prediction error signal from combinations of the plurality of coding modes, a frame-field decision for a macroblock having a frame coding structure and a macroblock having a field coding structure can be rapidly and appropriately performed.

The orthogonal transformation/quantization unit 1603 orthogonally transform (for example, discrete cosine transformation, integer transformation, or the like) to the prediction error signals generated by the prediction unit 1601 to quantize the transformation coefficients, and outputs the quantized orthogonally transformation coefficients and information of the coding modes (or information of motion vectors) to the second switching unit 1604 and the inverse orthogonal transformation/inverse quantization unit 1606.

The second switching unit 1604 performs a switching operation to output the orthogonal transformation coefficients, the information of the coding modes, and the like output from the orthogonal transformation/quantization unit 1603 to the coding mode control unit 1605 or a unit except for tentative coding units. More specifically, the second switching unit 1604 is controlled by the coding control unit 101 such that the output terminal of the second switching unit 1604 is connected to the coding mode control unit 1605 when there is a coding mode which can be selected by the macroblocks. In this manner, the prediction error signals and the coding costs of all the coding modes, which can be selected by the macroblocks can be calculated.

More specifically, when the output terminal of the second switching unit 1604 is connected to the coding mode control unit 1605, the coding cost calculating unit 1602 does not perform coding process in the subsequent processes (processes of the orthogonal transformation/quantization unit 1603→the coding mode control unit 1605). For this reason, processing load can be reduced.

The coding mode control unit 1605 performs a process of setting coding modes in the prediction unit 1601. The coding mode control unit 1605 also determines a coding mode having the minimum coding cost of the coding costs calculated in respective coding modes in the coding cost calculating unit 1602. More specifically, the coding mode control unit 1605 sequentially sets one executable coding mode or a plurality of executable coding modes in the prediction unit 1601 in a state in which the output of the coding mode control unit 1605 is connected to the coding mode control unit 1605 by the second switching unit 1604. The coding mode control unit 1605 determines a coding mode having the minimum coding cost in the coding costs of the respective coding modes. When the coding mode is determined by the coding mode control unit 1605, an output terminal of the second switching unit 1604 is directly connected to the outside of the tentative coding units to output the quantized transformation coefficient and the coding cost of the determined coding mode and coding information of the coding cost or the like.

The inverse orthogonal transformation/inverse quantization unit 1606 inversely quantizes the quantized orthogonal transformation coefficients quantized by orthogonal transformation/quantization unit 1603 to restore the orthogonal transformation coefficients. The inverse orthogonal transformation/inverse quantization unit 1606 performs an inverse orthogonal transformation process (for example, discrete cosine transformation, inverse integer transformation, or the like) to the restored orthogonal transformation coefficients to restore prediction error signals or the like and outputs the restored prediction error signals to the prediction decoding unit 1607.

The prediction decoding unit 1607 generates prediction signals from the prediction error signals, restore an image from the prediction signals, and stores the restored image in the frame memory 140 as a reference image. The reference image stored in the frame memory 140 is referred to in the process of generating prediction signals and prediction error signals performed by the prediction unit 1601.

In this case, the functional configurations of the first frame coding unit 131, the second frame coding unit 132, the first field coding unit 133, and the second field coding unit 134 are the same as those in the first embodiment. The configurations of the coding units may be the same as those of the coding units in the second to sixth embodiments.

A moving picture coding process in the moving picture coding apparatus 100 according to the embodiment arranged as described above will be described below. The same procedure (FIG. 4) as that of the first embodiment is performed with respect to all the processes of the moving picture coding.

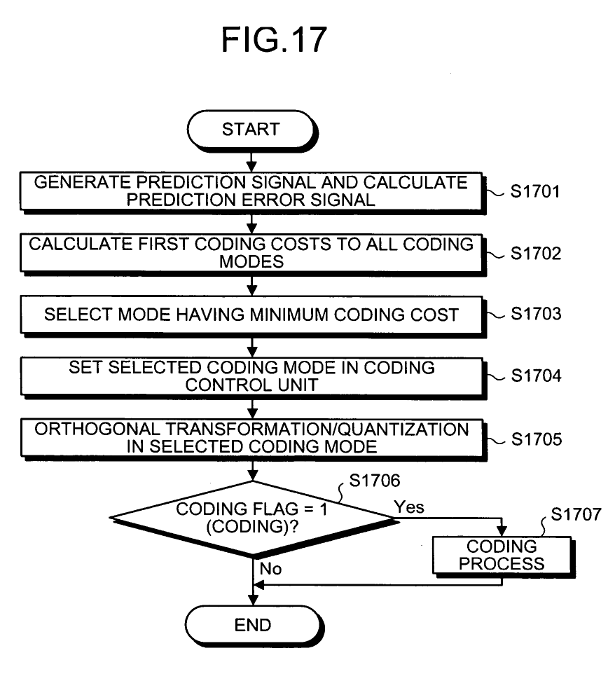

Tentative coding processes in steps S403, S404, S406, and S407 and coding processes in steps S410, S411, S412, and S413 in all the processes (FIG. 4) of moving picture coding will be described in detail. FIG. 17 is a flow chart showing a procedure of the tentative coding processes and the coding processes.

When the moving picture signals are input for respective macroblocks, coding of the input images is started for respective macroblocks. The prediction unit 1601 generates prediction signals from image signals of the input macroblocks according to coding process method by all the coding modes, which can be executed to the macroblocks to calculate prediction error signals which are pixel differences between the prediction signals and the input image signals (step S1701). In this case, the prediction signals and the prediction error signals are generated for the respective coding modes, which can be executed to the input macroblocks.

From the prediction error signals generated by the prediction unit 1601, the coding cost calculating unit 1602 calculates the coding costs by using Equation (3) to the input macroblocks for the respective coding modes, which can be executed to the input macroblocks (step S1702). The coding mode control unit 1605 selects a coding mode having the minimum value of the calculated first coding costs of the coding modes as a coding mode in which a coding process is performed (step S1703).

The coding mode control unit 207 sets the mode number of the coding mode having the minimum coding cost in an index representing the number of the selected coding mode and sets the coding mode having the mode number represented by the value of the index in the coding control unit 101 (step S1704). In this manner, an orthogonal transformation process and a quantization process corresponding to the coding mode having the mode number represented by the value of the index are performed by the orthogonal transformation/quantization unit 1603 (step S1705). More specifically, the orthogonal transformation/quantization unit 1603 orthogonal transforms the prediction error signals to quantize orthogonal transformation coefficients.

On the other hand, when the process is performed, the orthogonal transformation coefficients obtained by quantizing the prediction error signals are input to the inverse orthogonal transformation/inverse quantization unit 1606 and subjected to inverse quantization/inverse orthogonal transformation to reproduce the prediction error signals. A local decode image is generated by the prediction decoding unit 1607 and temporarily stored in the frame memory 140 as a reference image.

The second switching unit 1604 checks whether a coding flag is set at 1 or not to decide whether coding is performed or not (step S1706). When the coding flag is set at 1 (coding is performed) (step S1706), the second switching unit 1604 switches the output terminal to connect the output terminal to the outside of the tentative coding unit, and a coding process is performed in an optimum coding mode determined by the coding mode control unit 1605 (step S1707). In this manner, the coding process is performed by any one of the first frame coding unit 131, the second frame coding unit 132, the first field coding unit 133, and the second field coding unit 134.

On the other hand, when the coding flag is set at 0 in step S1706, the third switching unit 205 ends the process.

In the moving picture coding apparatus according to the embodiment, when an interlace-type moving picture is to be coded, a coding mode having the minimum value of coding costs calculated from prediction error signals of image signals input for respective selectable coding modes is determined as a coding mode in which a coding process is performed. For this reason, coding having high coding efficiency can be appropriately and accurately performed to make it possible to select the coding mode. Therefore, preferable coding modes can be selected depending on the contents of macroblocks or the like, appropriate coding having high compression efficiency can be realized, and the number of coding modes in which tentative coding processes are actually performed is reduced. Consequently, the amount of calculation can be considerably reduced, and load of the coding processes can be prevented from increasing. In particular, in the embodiment, since the coding mode is determined by only the coding costs calculated from the prediction error signals, load of tentative coding processes can be further reduced.

A moving picture coding apparatus according to the seventh embodiment, a coding mode in which a coding process is performed is determined by only coding costs calculated from prediction error signals. However, in a moving picture coding apparatus according to the eighth embodiment, coding costs are calculated from a bitrate and distortions calculated by tentative coding, and a coding mode in which a coding process is performed is determined by only the coding costs.

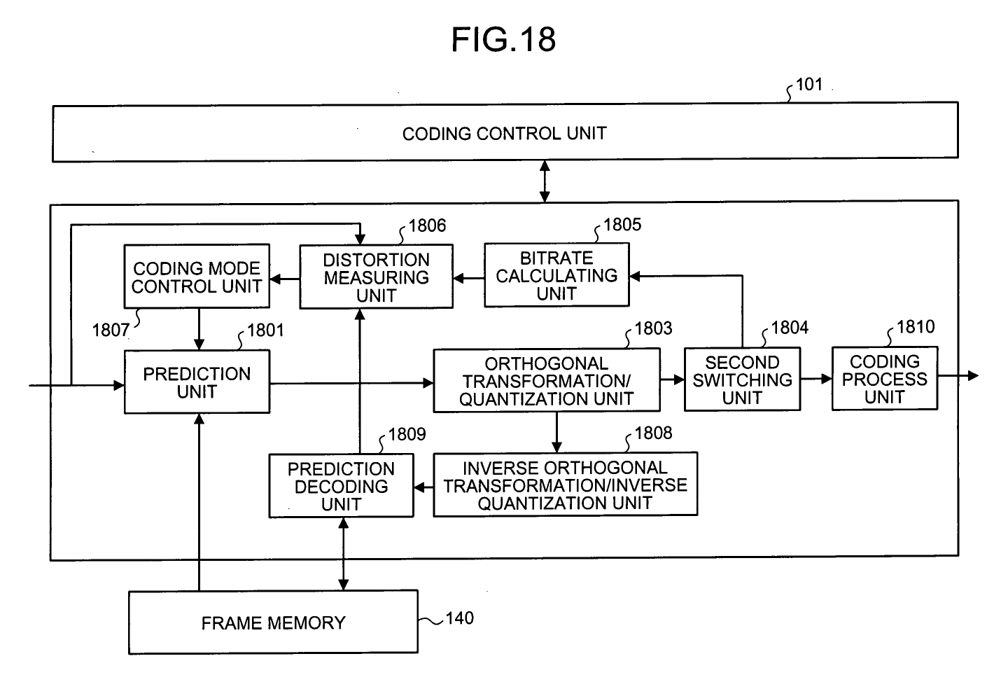

The functional configuration of the moving picture coding apparatus 100 according to the embodiment is the same as the moving picture coding apparatus according to the first embodiment. FIG. 18 is a block diagram showing functional configurations of a first frame tentative coding unit 111, a second frame tentative coding unit 112, a first field tentative coding unit 113, a second field tentative coding unit 114, a first frame coding unit 131, a second frame coding unit 132, a first field coding unit 133, and a second field coding unit 134.

Each of the first frame tentative coding unit 111, the second frame tentative coding unit 112, the first field tentative coding unit 113, the second field tentative coding unit 114, the first frame coding unit 131, the second frame coding unit 132, the first field coding unit 133, and the second field coding unit 134, as shown in FIG. 18, mainly includes a prediction unit 1801, an orthogonal transformation/quantization unit 1803, a second switching unit 1804, a bitrate calculating unit 1805, a distortion measuring unit 1806, a coding mode control unit 1807, an inverse orthogonal transformation/inverse quantization unit 1808, a prediction decoding unit 1809, and a coding process unit 1810.

For respective coding modes sequentially set by the coding mode control unit 1807, the prediction unit 1801 generates prediction signals by a coding process method determined by the coding modes while using a reference image temporarily stored in the frame memory 140 and generates prediction error signals which are pixel differences between the image signals of the input macroblocks and the generated prediction signals. When the set coding mode is related to inter-frame prediction coding, the prediction unit 1801 also performs a motion vector detection process.

The prediction unit 1801 may generate prediction signals with respect to all the coding modes corresponding to the macroblocks to be processed or may generate prediction signals with respect to only some coding modes.

The orthogonal transformation/quantization unit 1803 performs orthogonal transformation (for example discrete cosine transformation, integer transformation, or the like) to the prediction error signals generated by the prediction unit 1801 for the respective coding modes, quantizes the transformation coefficients, and output the quantized orthogonal transformation coefficients and information of the coding modes (or information of motion vectors) to the second switching unit 1804 and the inverse orthogonal transformation/inverse quantization unit 1808.

The second switching unit 1804 is to switch the orthogonal transformation coefficients output from the orthogonal transformation/quantization unit 1803, the information of the coding modes, and the like to an output to the bitrate calculating unit 1805 and an output to the coding process unit 1810.

The bitrate calculating unit 1805 temporarily codes signals representing the orthogonal transformation coefficients input from the second switching unit 1804 and the information of the motion vectors and measures a bitrate without outputting coded data (Tentative coding). In this case, in the embodiment, a bitrate obtained when entropy coding based on Huffman coding or arithmetic coding is measured, and entropy coded data is not output.

The distortion measuring unit 1806 is to measure a distortion (for example, square errors) which is an image difference between the reference images generated by the inverse orthogonal transformation/inverse quantization unit 1808 and the prediction decoding unit 1809 and temporarily stored in the frame memory 140 and an input image (original image obtained before coding) to be coded. In this case, the distortion is calculated in each of coding modes set by the coding mode control unit 1708. More specifically, a distortion representing a difference between an image obtained by restoring an image processed and coded in each coding mode and the input image is measured.

When the output terminal of the second switching unit 1804 is connected to the bitrate calculating unit 1805, the coding mode control unit 1807 sequentially sets executable coding modes in the prediction unit 1801 and calculates coding costs to determine a coding mode executed as a coding process. More specifically, when the processes are performed in the coding modes, the coding mode control unit 1807 digitizes the bitrate in the coding modes calculated by the bitrate calculating unit 1805 and the distortions of the coding modes calculated by the distortion measuring unit 1806, adds both the values according to Equation 4 to calculate coding costs, and determines a coding mode having the minimum coding cost.
Cost=D+λ×R (4)

Where D is a distortion, R is a bitrate, and λ is a constant.

In the embodiment, as the coding cost, a value obtained by adding a bitrate and a distortion. However, as the coding cost, not only the value but also a value based on the bitrate and the distortion can be used. In the digitization of the bitrate and the distortion, the bitrate may be emphasized, or the distortion may be emphasized, or one of the bitrate and the distortion may be determined by a user as a value to be emphasized.

The inverse orthogonal transformation/inverse quantization unit 1808 inversely quantizes the quantized orthogonal transformation coefficients quantized orthogonal transformation/quantization unit 1803 to restore the orthogonal transformation coefficients. The inverse orthogonal transformation/inverse quantization unit 1808 performs an inverse orthogonal transformation process (for example, discrete cosine transformation, inverse integer transformation, or the like) to the restored orthogonal transformation coefficients to restore prediction error signals or the like and outputs the restored prediction error signals to the prediction decoding unit 1809. The prediction decoding unit 1809 generates prediction signals from the prediction error signals and restores an image from the prediction signals to store the image as a reference image in the frame memory 140. The reference image stored in the frame memory 140 is referred to when the prediction unit 1801 generates the prediction signals and the prediction error signals and when the distortion measuring unit 1806 measures the distortion.

The coding process unit 1810 performs entropy coding to the orthogonal transformation coefficient and the coding information obtained and quantized by the orthogonal transformation/quantization unit 1803 in the coding mode determined by the coding mode control unit 1807 and outputs coding data outside.

The moving picture coding process in the moving picture coding apparatus 100 according to the embodiment arranged as described above will be described below. The same procedure (FIG. 4) as that of the first embodiment is performed with respect to all the processes of the moving picture coding.

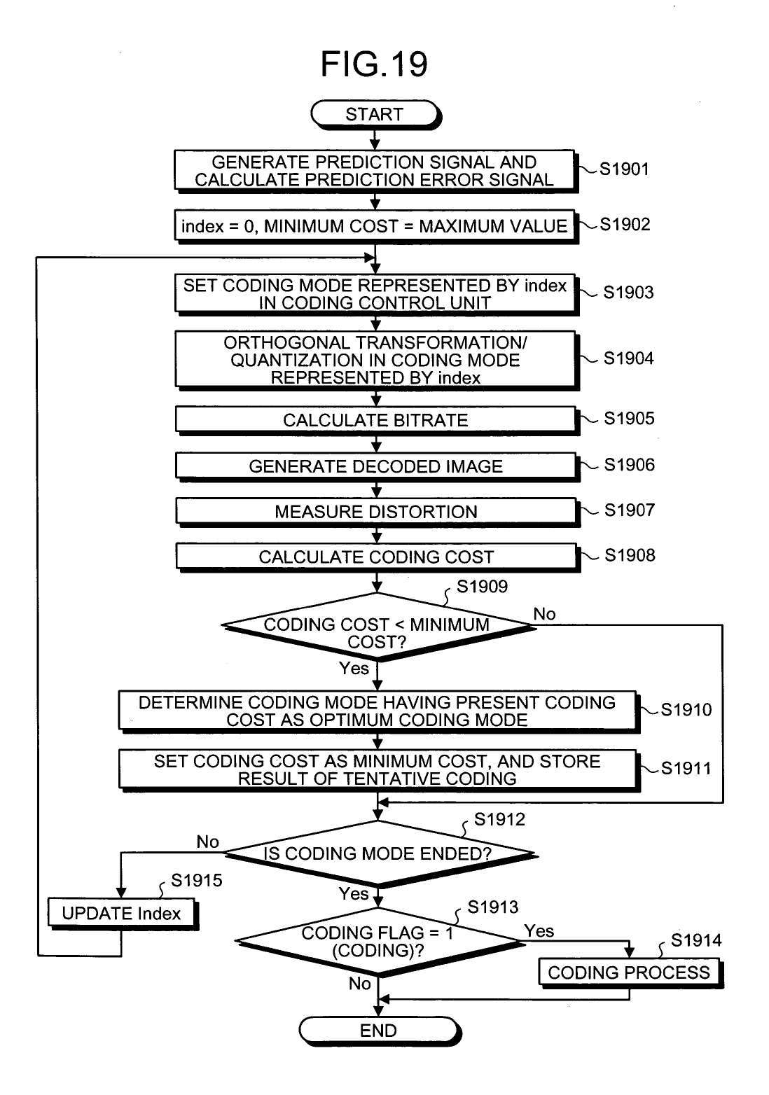

Tentative coding processes in steps S403, S404, S406, and S407 and coding processes in steps S410, S411, S412, and S413 in all the processes (FIG. 4) of moving picture coding will be described in detail. FIG. 19 is a flow chart showing a procedure of the tentative coding processes and the coding processes.

When the moving picture signals are input for respective macroblocks, coding of the input images is started for respective macroblocks. The prediction unit 1801 generates prediction signals from image signals of the input macroblocks according to coding process method by all the coding modes, which can be executed to the macroblocks to calculate prediction error signals which are pixel differences between the prediction signals and the input image signals (step S1901). In this case, the prediction signals and the prediction error signals are generated for the respective coding modes, which can be executed to the input macroblocks.

The coding mode control unit 1807 sets an index representing the number of a coding mode at 0 and initializes the minimum cost with the maximum value which is a predetermined arbitrary value (step S1902).

When an output of the second switching unit 1804 is connected to the bitrate calculating unit 1805, the coding mode control unit 1807 sets the coding mode having the modo number represented by the value of the index in the coding control unit 101 (step S1903). In this manner, an orthogonal transformation process and a quantization process corresponding to the coding mode having the mode number represented by the value of the index are performed by the orthogonal transformation/quantization unit 1803 (step S1904). More specifically, the orthogonal transformation/quantization unit 1803 orthogonally transforms the prediction error signal and quantizes an orthogonal transformation coefficient.

The bitrate calculating unit 1805 calculates a bitrate generated when entropy coding based on Huffman coding or arithmetic coding is performed to the quantized orthogonal transformation coefficient and the information of the motion vector (step S1905). However, entropy coding data is not output.

When the orthogonal transformation/quantization unit 1803 orthogonally transforms the prediction error signal and quantizes the orthogonal transformation coefficient in step S1904, and when the bitrate calculating unit 1805 performs a process of calculating a bitrate in step S1905, the orthogonal transformation coefficient obtained by quantizing the prediction error signal is input to the inverse orthogonal transformation/inverse quantization unit 1808 and subjected to inverse quantization/inverse orthogonal transformation to reproduce the prediction error signal. A local decode image, which is a decoded image is generated by the prediction decoding unit 1809 and temporarily stored in the frame memory 140 as a reference image. The generation of the reference image is performed to only the coding modes serving as candidates (step S1906).

The distortion measuring unit 1806 measures a distortion which is an image difference between the reference image in the frame memory 140 and the input image (original image obtained before coding) to be coded (step S1907).

The coding mode control unit 1807 calculates a coding cost by using Equation (4) from the bitrate calculated in step S1905 and the distortion measured in step S1907 (step S1908).

The coding mode control unit 1807 decides whether the calculated coding cost is smaller than the minimum cost or not (step S1909). When the coding cost is smaller than the minimum cost (step S1909: Yes), the coding mode control unit 1807 determines a coding mode corresponding to the present coding cost as an optimum coding mode (step S1910). The minimum cost is updated with the present coding cost, and a result of the tentative coding, i.e., coded data generated by a coding process in the coding mode corresponding to the mode number represented by the index is held in the frame memory 140 (step S1911).

The coding mode control unit 1807 decides whether the processes to all the coding modes are ended or not (step S1912). When the processes to all the coding modes are not ended (step S1912: No), the index is updated to be incremented by only 1 (step S1915), the processes in steps S1903 to S1911 are repeatedly executed. In this manner, a coding mode having the minimum coding cost is determined.

On the other hand, when the processes are ended to all the coding modes in step S1912 (step S1912: Yes), the second switching unit 1804 checks whether the coding flag is set at 1 or not to decide whether coding is performed or not (step S1913). When the coding flag is set at 1 (coding is performed) (step S1913: Yes), the second switching unit 1804 switches an output terminal to connect the output terminal to the coding process unit 1810 and performs a coding process in the optimum coding mode determined by the coding mode control unit 1807 (step S1914). In this manner, the coding process is performed by any one of the first frame coding unit 131, the second frame coding unit 132, the first field coding unit 133, and the second field coding unit 134.

On the other hand, when the coding flag is set at 0 in step S1913 (step S1913: No), the process is ended. In this manner, the coding cost of the optimum coding mode is output any one of the first frame tentative coding unit 111, the second frame tentative coding unit 112, the first field tentative coding unit 113, and the second field tentative coding unit 114.

In this manner, in the moving picture coding apparatus according to the embodiment, when an interlace-type moving picture is to be coded, coding costs of a plurality of selectable coding modes are calculated from the bitrate and the distortions calculated by performing tentative coding, so that a coding mode having the minimum coding cost of the calculated coding costs is determined as a coding mode in which a coding process is performed. For this reason, coding having high coding efficiency can be appropriately and accurately performed to make it possible to select a coding mode. Therefore, a preferable coding mode can be selected depending on the contents of macroblocks or the like, preferable coding having high compression efficiency can be realized, and the number of coding modes in which tentative coding processes are actually performed is reduced. Consequently, the amount of calculation can be considerably reduced, and load of the coding processes can be prevented from increasing. In particular, in this embodiment, since the coding mode is determined by only the coding costs calculated from the bitrate and the distortions, load of tentative coding processes can be more reduced.

In the moving picture coding apparatus according to the embodiment, a coding cost is calculated from a bitrate and a distortion. However, as in the moving picture coding apparatus according to the first embodiment, the bitrate itself may be used as the coding cost.

Each of the image coding apparatuses according to the first to eighth embodiments includes a control device such as a CPU, a memory device such as a ROM (Read Only Memory) or a RAM, an external storage device such as a HDD or a CD drive device, a display device such as a display unit, an input device such as a keyboard or a mouse and has a hardware configuration using an ordinary computer.

A moving picture coding program executed by each of the moving picture coding apparatuses according to the first to eighth embodiments is recorded on a computer readable recording medium such as a CD-ROM, or a flexible disk (FD), a CD-R, a DVD (Digital Versatile Disk) as a file in an installable format or an executable format and provided.

The moving picture coding program executed by each of the moving picture coding apparatus according to the first to eighth embodiments may be stored in a computer connected to a network such as the Internet and provided by downloading through the network. The moving picture coding program executed by the moving picture coding apparatus according to the embodiment may be provided or delivered through a network such as the Internet.

Each of the moving picture coding programs according to the first to eighth embodiments may be provided such that the moving picture coding program is built in a ROM or the like in advance.

Each of the moving picture coding programs executed by the moving picture coding apparatuses according to the first to eighth embodiments has a module configuration including the respective units (the first frame tentative coding unit 111, the second frame tentative coding unit 112, the first field tentative coding unit 113, the second field tentative coding unit 114, the frame-field determining unit 120, the first switching unit 121, the first frame coding unit 131, the second frame coding unit 132, the first field coding unit 133, the second field coding unit 134, the frame-field determining unit 120, and parts constituting these units). As actual hardware, a CPU (processor) reads the moving picture coding program from the storage medium and executes the program to load the units on a main memory device. In this manner, the first frame tentative coding unit 111, the second frame tentative coding unit 112, the first field tentative coding unit 113, the second field tentative coding unit 114, the frame-field determining unit 120, the first switching unit 121, the first frame coding unit 131, the second frame coding unit 132, the first field coding unit 133, and the second field coding unit 134 are generated on the main memory device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for coding a moving picture, comprising:
a prediction signal generating unit that generates a prediction signal for each coding mode from an input image and a reference image to generate a prediction error signal indicating a difference between a signal of the input image and the prediction signal, the input image being obtained from an interlaced moving picture;
a candidate mode selecting unit that calculates a first coding cost based on the prediction error signal for each coding mode to select a candidate coding mode based on the first coding cost;
a tentative coding unit that calculates a bitrate for each coding mode by performing a part of the coding on the prediction error signal for each first coding cost;
a coding mode control unit that calculates a second coding cost based on the bitrate to determine a coding mode among candidate coding modes based on the second coding cost;
a coding structure deciding unit that decides one of frame coding structure and field coding structure based on the second coding cost; and
a coding unit that performs coding according to the determined coding mode on the prediction error signal with the decided coding structure.

2. The apparatus according to claim 1, further comprising a distortion measuring unit that measures distortion which is a difference between the input image and a reference image decoded from the prediction error signal, wherein the coding mode control unit calculates the second coding cost from the bitrate and the distortion, and determines a coding mode among the candidates of coding modes based on the calculated second coding cost.

3. The apparatus according to claim 1, further comprising a mode limiting unit that limits a plurality of coding modes to a coding mode based on a coding structure of the input image, wherein
the candidate mode selecting unit that calculates a first coding cost representing an amount of the coding process, based on the prediction error signal, for the respective limited coding modes, and selects the candidates of the coding modes from the limited coding modes based on the first coding cost.

4. The apparatus according to claim 1, wherein the tentative coding unit comprises:
an orthogonal transformation/quantization unit that orthogonally transforms the prediction error signal, and quantizes an orthogonal transformation coefficient related to orthogonal transformation; and
a bitrate calculating unit that calculates the bitrate from a quantization result obtained by the orthogonal transformation/quantization unit.

5. An apparatus for coding a moving picture, comprising:
an adaptive mode selecting unit that selects at least one coding mode in which a coding is performed based on a type of an input image obtained from an interlaced moving picture;
a prediction unit that generates a prediction signal for each selected coding mode from the input image and a reference image to generate a prediction error signal indicating a difference between a signal of the input image and the prediction signal for each coding mode;
a tentative coding unit that performs a part of the coding on the prediction error signal for each selected coding mode to calculate a bitrate for each coding mode;
a coding mode control unit that calculates a coding cost based on the bitrate to determine a coding mode among the selected coding modes based on the coding cost;
a coding structure deciding unit that decides one of frame coding structure and field coding structure based on the coding cost; and
a coding unit that performs coding according to the determined coding mode on the prediction error signal with the decided coding structure.

6. The apparatus according to claim 5, further comprising:
a block size selecting unit that selects a block size to be coded based on an input image obtained from a moving picture to select the coding mode corresponding to the selected block size, wherein
the adaptive mode selecting unit selects at least one coding mode in which a coding is performed, from the coding mode selected by the block size selecting unit based on a type of the input image.

7. The apparatus according to claim 6, wherein
the block size selecting unit selects a block size to be coded based on the type of the input image to select the coding mode corresponding to the selected block size.

8. The apparatus according to claim 5, further comprising
a motion searching accuracy selecting unit that, when a coding of the coding mode selected by the adaptive mode selecting unit is an inter-frame prediction coding, selects at least one coding mode in which a coding designating a motion searching accuracy representing an accuracy of a pixel position in motion vector searching is performed.

9. The apparatus according to claim 8, wherein
the motion searching accuracy selecting unit, when the coding of the coding mode selected by the adaptive mode selecting unit is an inter-frame prediction coding, selects at least one coding mode in which the coding designating the motion searching accuracy based on the type of the input image is performed.

10. The apparatus according to claim 5, wherein
the tentative coding unit comprises:
an orthogonal transformation/quantization unit that orthogonally transforms the prediction error signal generated by the prediction unit to quantize orthogonal transformation coefficients related to orthogonal transformation; and
a bitrate calculating unit that calculates the bitrate from a quantization result obtained by the orthogonal transformation/quantization unit.

11. An apparatus for coding a moving picture, comprising:
a prediction unit that generates a prediction signal for each coding mode from an input image obtained from an interlaced moving picture, and a reference image to generate a prediction error signal indicating a difference between a signal of the input image and the prediction signal for each coding mode;
a coding cost calculating unit that calculates a coding cost for each coding mode based on the prediction error signal;
a coding mode control unit that determines the coding mode based on the coding cost;
a coding structure deciding unit that decides one of frame coding structure and field coding structure based on the coding cost; and
a coding unit that performs coding according to the determined coding mode on the prediction error signal with the decided coding structure.

12. An apparatus for coding a moving picture, comprising:
a prediction unit that generates a prediction signal for each coding mode from an input image obtained from an interlaced moving picture, and a reference image to generate a prediction error signal indicating a difference between a signal of the input image and the prediction signal for each coding mode;
a tentative coding unit that performs a part of the coding on the prediction error signal for each coding mode to calculate a bitrate for each coding mode;
a coding mode control unit that calculates a coding cost based on the bitrate to determine the coding mode based on the coding cost;
a coding structure deciding unit that decides one of frame coding structure and field coding structure based on the coding cost; and
a coding unit that performs coding according to the determined coding mode on the prediction error signal with the decided coding structure.

13. The apparatus according to claim 12, further comprising:
a distortion measuring unit that measures distortion which is a difference between the input image and a reference image decoded from the prediction error signal, wherein
the coding mode control unit calculates the coding cost from the bitrate and the distortion to determine the coding mode based on the calculated coding cost.

14. The apparatus according to claim 12, wherein
the tentative coding unit comprises:
an orthogonal transformation/quantization unit that orthogonally transforms the prediction error signal to quantize orthogonal transformation coefficients related to orthogonal transformation; and
a bitrate calculating unit that calculates the bitrate from a quantization result obtained by the orthogonal transformation/quantization unit.

15. A computer program product having a computer readable medium including programmed instructions for coding a moving picture, wherein the instructions, when executed by a computer, cause the computer to perform:
generating a prediction signal for each coding mode from an input image and a reference image;
generating a prediction error signal indicating a difference between a signal of the input image and the prediction signal, the input image being obtained from an interlaced moving picture;
calculating a first coding cost based on the prediction error signal for each coding mode;
selecting a candidate coding mode based on the first coding cost;
calculating a bitrate for each coding mode by performing a part of the coding on the prediction error signal for each first coding cost;
calculating a second coding cost based on the bitrate;
determining a coding mode among candidate coding modes based on the second coding cost;
deciding one of frame coding structure and field coding structure based on the second coding cost; and
performing coding according to the determined coding mode on the prediction error signal with the decided coding structure.

16. A computer program product having a computer readable medium including programmed instructions for coding a moving picture, wherein the instructions, when executed by a computer, cause the computer to perform:
selecting at least one coding mode in which a coding is performed based on a type of an input image obtained from an interlaced moving picture;
generating a prediction signal for each selected coding mode from the input image and a reference image;
generating a prediction error signal indicating a difference between a signal of the input image and the prediction signal for each coding mode;
performing a part of the coding on the prediction error signal for each selected coding mode;
calculating a bitrate for each coding mode;
calculating a coding cost based on the bitrate;
determining a coding mode among the selected coding modes based on the coding cost;
deciding one of frame coding structure and field coding structure based on the coding cost; and
performing coding according to the determined coding mode on the prediction error signal with the decided coding structure.

17. A computer program product having a computer readable medium including programmed instructions for coding a moving picture, wherein the instructions, when executed by a computer, cause the computer to perform:
generating a prediction signal for each coding mode from an input image obtained from an interlaced moving picture, and a reference image;
generating a prediction error signal indicating a difference between a signal of the input image and the prediction signal for each coding mode;
calculating a coding cost for each coding mode based on the prediction error signal;
determining the coding mode based on the coding cost;
deciding one of frame coding structure and field coding structure based on the coding cost; and
performing coding according to the determined coding mode on the prediction error signal with the decided coding structure.

18. A computer program product having a computer readable medium including programmed instructions for coding a moving picture, wherein the instructions, when executed by a computer, cause the computer to perform:
generating a prediction signal for each coding mode from an input image obtained from an interlaced moving picture, and a reference image;
generating a prediction error signal indicating a difference between a signal of the input image and the prediction signal for each coding mode;
performing a part of the coding on the prediction error signal for each coding mode;
calculating a bitrate for each coding mode;
calculating a coding cost based on the bitrate to determine the coding mode based on the coding cost;
deciding one of frame coding structure and field coding structure based on the coding cost; and
performing coding according to the determined coding mode on the prediction error signal with the decided coding structure.
